(19) United States
(12) Patent Application Publication
(10) Pub. No.: US 2013/0033478 A1
(43) Pub. Date: Feb. 7, 2013

(54) METHOD FOR DRIVING PLASMA DISPLAY PANEL AND PLASMA DISPLAY DEVICE

(71) Applicants: Toshiyuki Maeda, Hyogo (JP); Takateru Sawada, Osaka (JP)

(72) Inventors: Toshiyuki Maeda, Hyogo (JP); Takateru Sawada, Osaka (JP)

(73) Assignee: PANASONIC CORPORATION, Osaka (JP)

(21) Appl. No.: 13/641,039

(22) PCT Filed: Apr. 13, 2011
(86) PCT No.: PCT/JP2011/002176

§ 371 Date: Oct. 12, 2012

(30) Foreign Application Priority Data
Apr. 13, 2010 (JP) 2010-091891

(51) Int. Cl. G09G 3/28; G06F 3/038

(52) U.S. Cl. 345/211; 345/60

(57) ABSTRACT

The luminance of black level of a display image is reduced to improve the contrast, the address discharge is stably caused, and the image display quality of a plasma display apparatus is improved. For this purpose, a specific-cell initializing subfield having an initializing period in which a forced initializing operation is performed in a specific discharge cell is disposed, a pre-reset period is disposed after a sustain period in the subfield immediately before the specific-cell initializing subfield. In the pre-reset period, first auxiliary discharge is caused in the discharge cell having undergone sustain discharge in the sustain period immediately before the pre-reset period. Then, second auxiliary discharge is caused in the discharge cell where the forced initializing operation is performed in the initializing period of the specific-cell initializing subfield immediately after the pre-reset period.

### TECHNICAL FIELD

The present invention relates to a driving method of a plasma display panel used in a wall-mounted television or a large monitor, and a plasma display apparatus.

### BACKGROUND ART

A plasma display panel (hereinafter referred to as “panel”) typical as a display device has many discharge cells between a front substrate and a rear substrate that are faced to each other. The front substrate has the following elements:
a plurality of display electrode pairs disposed in parallel on a front glass substrate; and
a dielectric layer and protective layer disposed so as to cover the display electrode pairs.
   Here, each display electrode pair is formed of a pair of scan electrode and sustain electrode.

The rear substrate has the following elements:
a plurality of data electrodes disposed in parallel on a rear glass substrate;
a dielectric layer disposed so as to cover the data electrodes;
a plurality of barrier ribs disposed on the dielectric layer in parallel with the data electrodes; and
phosphor layers disposed on the surface of the dielectric layer and on side surfaces of the barrier ribs.

The front substrate and rear substrate are faced to each other so that the display electrode pairs and the data electrodes three-dimensionally intersect, and are sealed. Discharge gas containing xenon with a partial pressure of 5%, for example, is filled into a discharge space in the sealed product. Discharge cells are disposed in the intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color image display.

A subfield method is generally used as a method of driving the panel. In this subfield method, one field is divided into a plurality of subfields, and light emission and no light emission in each discharge cell is controlled in each subfield. The frequency of light emission occurring in one field is controlled, thereby performing gradation display.

Each subfield has an initializing period, an address period, and a sustain period.

In the initializing period, an initializing waveform is applied to each scan electrode, and initializing discharge is caused in each discharge cell. Thus, wall charge required for a subsequent address operation is formed in each discharge cell, and a priming particle (an excitation particle for causing discharge) for stably causing address discharge is generated.

In the address period, a scan pulse is sequentially applied to scan electrodes, and an address pulse is selectively applied to data electrodes based on an image signal to be displayed. Thus, address discharge is caused between the scan electrode and the data electrode of the discharge cell to emit light, thereby producing wall charge in the discharge cell (hereinafter, this operation is referred to as “address”).

In the sustain period, as many sustain pulses as a number determined for each subfield are alternately applied to the display electrode pairs formed of the scan electrodes and the sustain electrodes. Thus, sustain discharge is caused in the discharge cell having undergone address discharge, thereby emitting light in the phosphor layer of this discharge cell (hereinafter, light emission by sustain discharge in a discharge cell is referred to as “lighting”, and no light emission is referred to as “no-lighting”). Thus, light is emitted in each discharge cell at a luminance corresponding to the luminance weight determined for each subfield. Thus, light is emitted at a luminance corresponding to the gradation value of an image signal in each discharge cell of the panel, and an image is displayed on the image display region of the panel.

One of important factors for improving the quality of an image displayed on the panel is to improve the contrast. As one of panel driving methods using a subfield method, a driving method is disclosed where light emission related to no gradation display is minimized and the contrast of an image displayed on the panel is improved.

In this driving method, in the initializing period of one of a plurality of subfields constituting one field, an initializing operation of causing initializing discharge in all discharge cells is performed. In the initializing period of other subfields, an initializing operation of selectively causing initializing discharge in the discharge cell that has undergone sustain discharge in the sustain period of the immediately preceding subfield is performed.

The luminance (hereinafter, referred to as “luminance of black level”) in a black display region that does not cause sustain discharge is varied by light emission occurring regardless of the magnitude of the gradation value. This light emission includes light emission caused by initializing discharge, for example. In the driving method, the light emission in the black display region is only feeble light emission when the initializing operation of causing initializing discharge in all discharge cells is performed. Thus, the luminance of black level of an image displayed on the panel can be reduced and an image of sharp contrast can be displayed on the panel (for example, Patent Literature 1).

Further, a driving method having the following periods is disclosed (for example, Patent Literature 2):
an initializing period in which an initializing waveform having a rising portion having a gentle ramp part where the voltage increases gradually and a falling portion having a gentle ramp part where the voltage decreases gradually is applied to a scan electrode, and initializing discharge is caused in the discharge cell that has undergone sustain discharge in the sustain period of the immediately preceding subfield; and
immediately before any initializing period of one field, a period in which feeble discharge is caused between the sustain electrode and the scan electrode in all discharge cells.
   In this driving method, the luminance of black level of an image displayed on the panel can be reduced and the visibility of black can be improved.

Further, the driving method where, after an operation of applying a sustain pulse to a display electrode pair is completed, an increasing ramp voltage is applied to the sustain electrode to erase the wall charge in a discharge cell in the sustain period (for example, Patent Literature 3).

In the driving method described in Patent Literature 1, for example, by setting the frequency of initializing operations of causing initializing discharge in all discharge cells at once per field, the luminance of black level of the display image can be reduced and the contrast can be improved comparing with the case where initializing discharge is caused in all discharge cells in each field.

However, as the screen of the panel has been enlarged and the definition has been enhanced recently, further improvement in image display quality is demanded.

### CITATION LIST

Patent Literature

PLT 1

Unexamined Japanese Patent Publication No. 2000-242224

PLT 2

Unexamined Japanese Patent Publication No. 2004-37883

PLT 3

Unexamined Japanese Patent Publication No. 2004-348140

### SUMMARY OF THE INVENTION

In a driving method of a panel of the present invention, gradation display is performed on a panel that has a plurality of discharge cells each of which includes a display electrode pair formed of a scan electrode and a sustain electrode while a plurality of subfields having an initializing period, an address period, and a sustain period is disposed in one field. A specific-cell initializing subfield having an initializing period for performing a forced initializing operation in a specific discharge cell is disposed, and a pre-reset period is disposed after the sustain period in the subfield immediately before the specific-cell initializing subfield. In the pre-reset period, first auxiliary discharge is caused in the discharge cell where sustain discharge has been caused in the sustain period immediately before the pre-reset period, and then second auxiliary discharge is caused in the discharge cell where the forced initializing operation is performed in the initializing period of the specific-cell initializing subfield immediately after the pre-reset period.

Thus, the frequency of the forced initializing operation in each discharge cell can be made to be once every a plurality of fields, so that the luminance of black level can be made to be smaller than that in a configuration where initializing discharge is caused in each discharge cell at a rate of once per field. Initializing discharge can be stably caused in the specific-cell initializing subfield by the first auxiliary discharge and second auxiliary discharge, so that an address operation after the initializing operation can be stably performed. Therefore, the luminance of black level of the display image can be reduced to improve the contrast, the address discharge can be stably caused, and the image display quality in the plasma display apparatus can be improved.

In a driving method of a panel of the present invention, the voltage applied to a discharge cell in order to cause the first auxiliary discharge may be first ramp voltage that decreases from 0 (V) to negative-polarity voltage, and the voltage applied to a discharge cell in order to cause the second auxiliary discharge may be second ramp voltage that decreases from 0 (V) to negative-polarity voltage. Thus, the first auxiliary discharge and second auxiliary discharge can be caused as feeble discharge, so that the wall charge in the discharge cell can be adjusted appropriately.

In a driving method of a panel of the present invention, the second ramp voltage may be applied to a scan electrode, and positive-polarity voltage may be applied to a sustain electrode in the period in which the second ramp voltage is applied to the scan electrode. Thus, the second auxiliary discharge can be caused even in the discharge cell where the first auxiliary discharge has been caused.

In a driving method of a panel of the present invention, in the period in which the second ramp voltage is applied to the discharge cell where the second auxiliary discharge is caused, third ramp voltage which decreases from a predetermined positive-polarity voltage to a voltage higher than the minimum voltage of the second ramp voltage may be applied to the discharge cell where the second auxiliary discharge is not caused. This operation can prevent unnecessary discharge from occurring in the pre-reset period in the discharge cell where the forced initializing operation is not performed in the initializing period of the specific-cell initializing subfield immediately after the pre-reset period.

In a driving method of a panel of the present invention, the specific-cell initializing subfield may be set as the first subfield of one field, and the subfield having the pre-reset period may be set as the final subfield of one field.

A plasma display apparatus of the present invention has the following elements
a panel that has a plurality of discharge cells each of which includes a display electrode pair formed of a scan electrode and a sustain electrode, has a plurality of subfields having an initializing period, an address period, and a sustain period in one field, has a subfield having a specific-cell initializing period, and performs gradation display;
a sustain electrode driver circuit for driving the sustain electrodes; and
a scan electrode driver circuit that generates one of a forced initializing waveform and a selective initializing waveform and applies it to the scan electrodes in the initializing period, and applies the forced initializing waveform to a specific scan electrode in the specific-cell initializing period, where the forced initializing waveform causes initializing discharge in the discharge cells and the selective initializing waveform causes initializing discharge in the discharge cell having undergone sustain discharge in the sustain period of the immediately preceding subfield.
   In the subfield immediately before the subfield having the specific-cell initializing period, a pre-reset period is disposed after the sustain period. In the pre-reset period, the scan electrode driver circuit applies, to the scan electrodes, first ramp voltage for causing first auxiliary discharge in the discharge cell where sustain discharge has been caused in the sustain period immediately before the pre-reset period. Then, the scan electrode driver circuit applies second ramp voltage to the scan electrode to which the forced initializing waveform is applied in the specific-cell initializing period immediately after the pre-reset period. The sustain electrode driver circuit applies positive-polarity voltage to the sustain electrodes while the scan electrode driver circuit applies the second ramp voltage to the scan electrode.

Thus, the frequency of the forced initializing operation in each discharge cell can be made to be once every a plurality of fields, so that the luminance of black level can be made smaller than that in a configuration where initializing discharge is caused in each discharge cell at a rate of once per field. Initializing discharge can be stably caused in the specific-cell initializing period by the first auxiliary discharge and second auxiliary discharge, so that an address operation after the initializing operation can be stably performed. Therefore, the luminance of black level of the display image can be reduced to improve the contrast, the address discharge can be stably caused, and the image display quality in a plasma display apparatus can be improved.

In a plasma display apparatus of the present invention, the scan electrode driver circuit may generate the first ramp voltage and second ramp voltage as the ramp voltages that decrease from 0 (V) to a negative-polarity voltage. Thus, the scan electrode driver circuit can generate the first auxiliary discharge and second auxiliary discharge as feeble discharge, so that the wall charge in the discharge cell can be adjusted appropriately.

In a plasma display apparatus of the present invention, the scan electrode driver circuit may have the following configuration: while the second ramp voltage is applied to the scan electrode, third ramp voltage which decreases from a predetermined positive-polarity voltage to a voltage higher than the minimum voltage of the second ramp voltage is applied to the scan electrode to which the selective initializing waveform is applied in the specific-cell initializing period immediately after the pre-reset period. This operation can prevent unnecessary discharge from occurring in the pre-reset period in the discharge cell where the forced initializing operation is not performed in the specific-cell initializing period immediately after the pre-reset period.

### BRIEF DESCRIPTION OF DRAWINGS

FIG. 1 is an exploded perspective view showing a structure of a panel used in a plasma display apparatus in accordance with an exemplary embodiment of the present invention.

FIG. 2 is an electrode array diagram of the panel used in the plasma display apparatus in accordance with the exemplary embodiment of the present invention.

FIG. 3 is a diagram showing one example of a generation pattern of a forced initializing operation and a selective initializing operation in accordance with the exemplary embodiment of the present invention.

FIG. 4 is a waveform diagram showing one example of a driving voltage waveform to be applied to each electrode of a panel used in the plasma display apparatus in accordance with the exemplary embodiment of the present invention.

FIG. 5 is a circuit block diagram of the plasma display apparatus in accordance with the exemplary embodiment of the present invention.

FIG. 6 is a circuit diagram showing one configuration example of a scan electrode driver circuit in accordance with the exemplary embodiment of the present invention.

FIG. 7 is a timing chart showing one example of an operation of the scan electrode driver circuit in a pre-reset period and in a specific-cell initializing period in accordance with the exemplary embodiment of the present invention.

FIG. 8 is a diagram showing one example of another waveform of down-ramp voltage L5 in accordance with the exemplary embodiment of the present invention.

FIG. 9 is a waveform diagram showing another example of the driving voltage waveform to be applied to each electrode of the panel used in the plasma display apparatus in accordance with the exemplary embodiment of the present invention.

### DESCRIPTION OF EMBODIMENTS

A plasma display apparatus in accordance with an exemplary embodiment of the present invention will be described hereinafter with reference to the accompanying drawings.

### Exemplary Embodiment

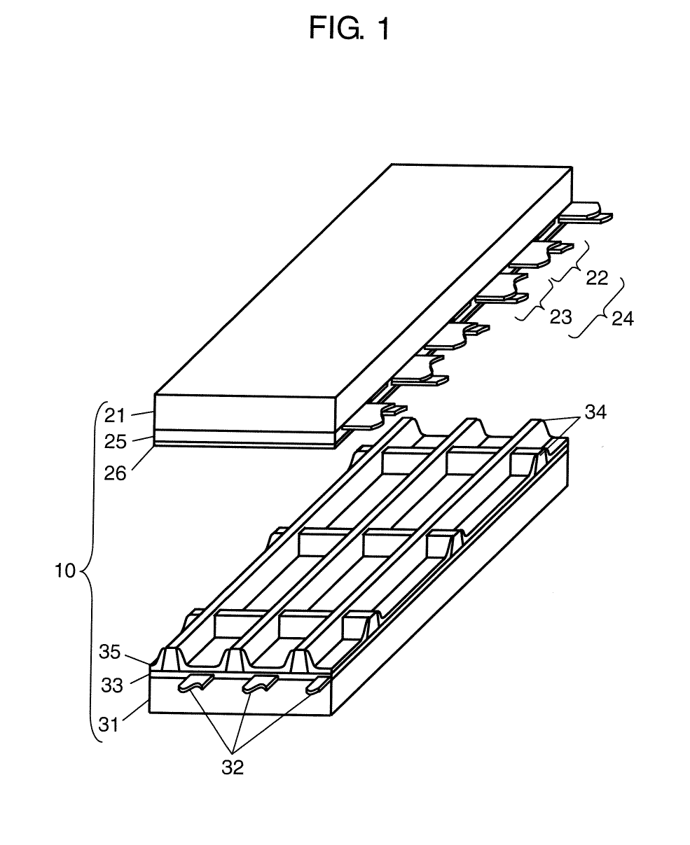

FIG. 1 is an exploded perspective view showing the structure of panel 10 used in a plasma display apparatus in accordance with an exemplary embodiment of the present invention. A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25.

Protective layer 26 is made of a material mainly made of magnesium oxide (MgO) that has a large electron emission coefficient and has high durability.

A plurality of data electrodes 32 is formed on glass-made rear substrate 31, dielectric layer 33 is formed so as to cover data electrodes 32, and mesh barrier ribs 34 are formed on dielectric layer 33. Phosphor layers 35 for emitting lights of respective colors of red (R), green (G), and blue (B) are formed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and the outer peripheries of them are sealed by a sealing material such as glass fit. The discharge space is filled with mixed gas of neon and xenon as discharge gas, for example. In the present exemplary embodiment, discharge gas where xenon partial pressure is set at about 10% is employed for improving the luminous efficiency.

The discharge space is partitioned into a plurality of sections by barrier ribs 34. Discharge cells are formed in the intersecting parts of display electrode pairs 24 and data electrodes 32. Thus, the plurality of discharge cells are formed on panel 10.

Then, discharge is caused in the discharge cells, and light is emitted (lighting in the discharge cells) in phosphor layers 35 of them, thereby displaying a color image on panel 10.

In panel 10, one pixel is formed of three consecutive discharge cells arranged in the extending direction of display electrode pairs 24. The three discharge cells are a discharge cell for emitting light of red color (R), a discharge cell for emitting light of green color (G), and a discharge cell for emitting light of blue color (B).

The structure of panel 10 is not limited to the above-mentioned one, but may be a structure having striped barrier ribs arranged only in the vertical direction (column direction), for example. The mixing percentage of discharge gas is not limited to the above-mentioned values, but may be another value.

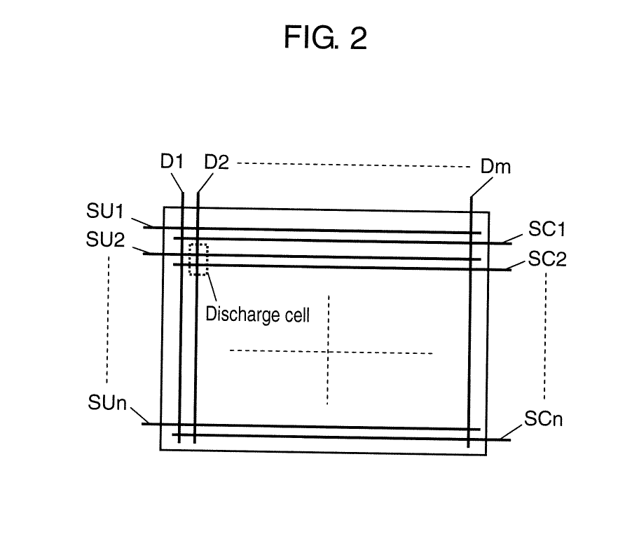

FIG. 2 is an electrode array diagram of panel 10 used in the plasma display apparatus in accordance with the exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended horizontally (row direction), and m data electrode D1 through data electrode Dm (data electrodes 32 in FIG. 1) extended vertically (column direction). A discharge cell is formed in the part where a pair of scan electrode SCi (i is 1 through n) and sustain electrode SUi intersect with one data electrode Dk (k is 1 through m). In other words, on one display electrode pair 24, m discharge cells are formed and m/3 pixels are formed. Thus, m×n discharge cells are formed in the discharge space, the region having m×n discharge cells defines the image display region of panel 10. In the panel where the number of pixels is 1920×1080, for example, m is 1920×3 and n is 1080.

Next, a driving voltage waveform and its operation for driving panel 10 are described schematically.

The plasma display apparatus of the present embodiment displays gradation on panel 10 using a subfield method. In this subfield method, the plasma display apparatus divides one field into a plurality of subfields on the time axis, and sets luminance weight for each subfield. Each subfield has an initializing period, an address period, and a sustain period.

In the sustain period of each subfield, as many sustain pulses as the number derived by multiplying the luminance weight of each subfield by a predetermined luminance magnification are applied to each display electrode pair 24. In the address period of each subfield, light emission and no light emission of each discharge cell in each subfield is controlled by causing address discharge in a discharge cell to emit light. Then, by controlling the light emission and no light emission of each discharge cell in each subfield, an image on panel 10 is displayed.

The luminance weight means the ratio between the luminances displayed in respective subfields, and as many sustain pulses as the number corresponding to the luminance weight are generated in each subfield in the sustain period. Therefore, in the subfield of luminance weight “8”, light is emitted at a luminance about eight times that in the subfield of luminance weight “1”, and light is emitted at a luminance about four times that in the subfield of luminance weight “2”. Therefore, various gradations can be displayed on panel 10 by selectively emitting light in each subfield using a combination corresponding to the image signal, and an image can be displayed on panel 10.

In the initializing period, an initializing operation of causing the initializing discharge in a discharge cell and producing, on each electrode, wall charge required for address discharge in the subsequent address period is performed. In the present exemplary embodiment, one of two initializing operations, namely “forced initializing operation” and “selective initializing operation”, is performed in the initializing period. In the forced initializing operation, initializing discharge is caused in a discharge cell regardless of the operation of the immediately preceding subfield. In the selective initializing operation, initializing discharge is caused only in a discharge cell having undergone sustain discharge in the sustain period in the immediately preceding subfield.

In the initializing period of the first subfield (subfield SF1) of one field, “specific-cell initializing operation” is performed. In the initializing periods of the other subfields, the selective initializing operation is performed in all discharge cells. In the specific-cell initializing operation, the forced initializing operation is performed in a specific discharge cell, and the selective initializing operation is performed in the other discharge cells. Therefore, in the initializing period of the first subfield (subfield SF1) of one field, a forced initializing waveform for the forced initializing operation is applied to the specific discharge cell, and a selective initializing waveform for the selective initializing operation is applied to the other discharge cells. Hereinafter, the initializing period in which the specific-cell initializing operation is performed is referred to as “specific-cell initializing period”, and the subfield having the specific-cell initializing period is referred to as “specific-cell initializing subfield”. The initializing period in which the selective initializing operation is performed in all discharge cells is referred to as “selective initializing period”, and the subfield having the selective initializing period is referred to as “selective initializing subfield”.

In the present exemplary embodiment, for example, one field is formed of eight subfields, namely subfield SF1 through subfield SF8, and the respective subfields have luminance weights of (1, 2, 4, 8, 16, 32, 64, 128). Subfield SF1 is set as the specific-cell initializing subfield, and subfield SF2 through subfield SF8 are set as the selective initializing subfields.

In the present exemplary embodiment, “first field” and “second field”, which are different from each other in the discharge cell where the forced initializing operation is performed in the specific-cell initializing subfield, are alternately generated, thereby driving panel 10. Hereinafter, the generation pattern of the forced initializing operation is described.

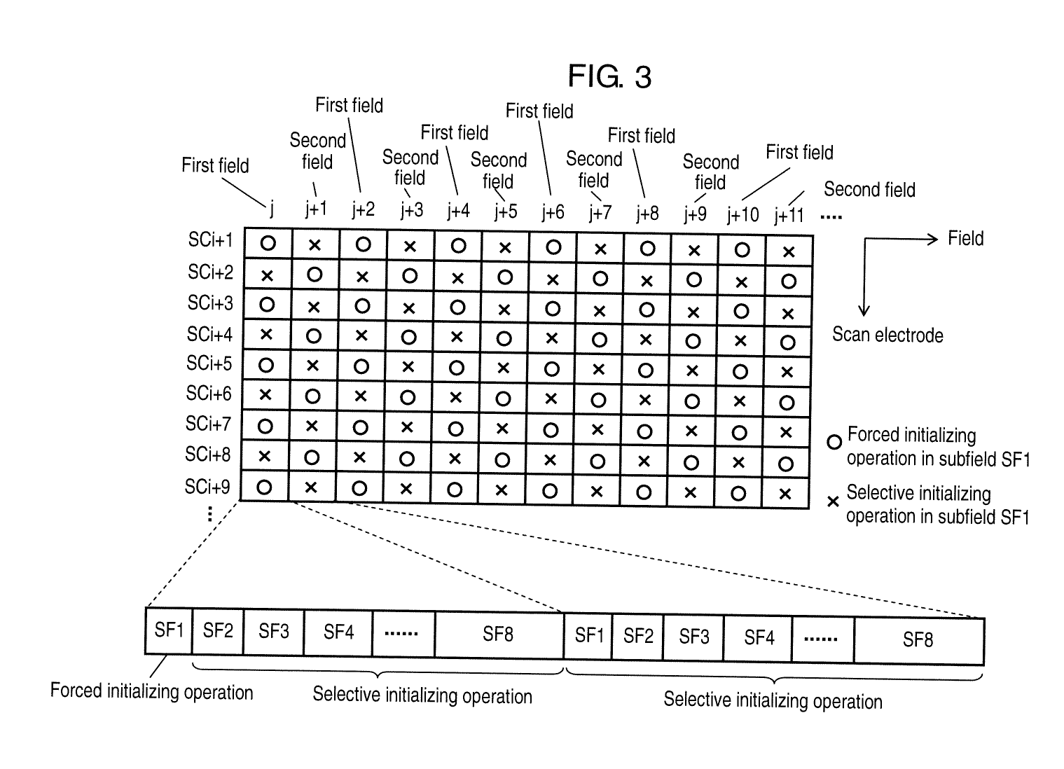

FIG. 3 is a diagram showing one example of a generation pattern of the forced initializing operation and the selective initializing operation in accordance with the exemplary embodiment of the present invention. In FIG. 3, the horizontal axis shows the fields, and the vertical axis shows scan electrodes 22. “0” of FIG. 3 shows that the forced initializing operation is performed in the initializing period of subfield SF1 as the specific-cell initializing subfield, and “x” shows that the selective initializing operation is performed in the initializing period.

In the present exemplary embodiment, in the specific-cell initializing subfield in the first field, the forced initializing operation is performed in the discharge cells on odd-numbered scan electrodes 22 in view of the layout as shown in FIG. 3. In the specific-cell initializing subfield in the second field, the forced initializing operation is performed in the discharge cells on even-numbered scan electrodes 22 in view of the layout. Then, “first field” and “second field” are alternately generated. Thus, the forced initializing operation is performed once every two fields in each discharge cell in the present exemplary embodiment.

In the present exemplary embodiment, by driving panel 10, light emission for causing increase in luminance of black level is minimized to reduce the luminance of black level, and the contrast ratio of a display image is improved. This is for the following reason.

One of the factors for increasing the luminance of black level is light emission by initializing discharge. However, the selective initializing operation does not substantially affect the brightness of the luminance of black level because discharge does not occur in the discharge cell having undergone no sustain discharge in the immediately preceding subfield. While, the forced initializing operation affects the brightness of the luminance of black level because initializing discharge occurs in the discharge cell regardless of the operation in the immediately preceding subfield. In other words, as the frequency of the forced initializing operation increases, the luminance of black level increases. Therefore, by reducing the frequency of the forced initializing operation in each discharge cell, the luminance of black level of the display image can be reduced and the contrast can be improved.

In the present exemplary embodiment, as shown in FIG. 3, the first field and second field are alternately generated. The first field has a specific-cell initializing subfield where the forced initializing operation is performed in the discharge cells formed on odd-numbered scan electrodes 22 in view of the layout. The second field has a specific-cell initializing subfield where the forced initializing operation is performed in the discharge cells formed on even-numbered scan electrodes 22 in view of the layout.

Thus, the frequency of the forced initializing operation in each discharge cell can be set at once every two fields. Therefore, in this configuration, the frequency of the forced initializing operation in each discharge cell can be reduced to a half that in the configuration where the forced initializing operation is performed in all discharge cells in each field, the luminance of black level can be reduced, and the contrast ratio of the image displayed on panel 10 can be improved.

Next, the first field and second field are described. As discussed above, in the present exemplary embodiment, each of the first field and second field is formed of eight subfields, namely subfield SF1 through subfield SF8, and the respective subfields are set to have luminance weights of (1, 2, 4, 8, 16, 32, 64, 128). In the present exemplary embodiment, however, the number of subfields and the luminance weight of each subfield are not limited to the above-mentioned values. The subfield structure may be changed based on an image signal or the like.

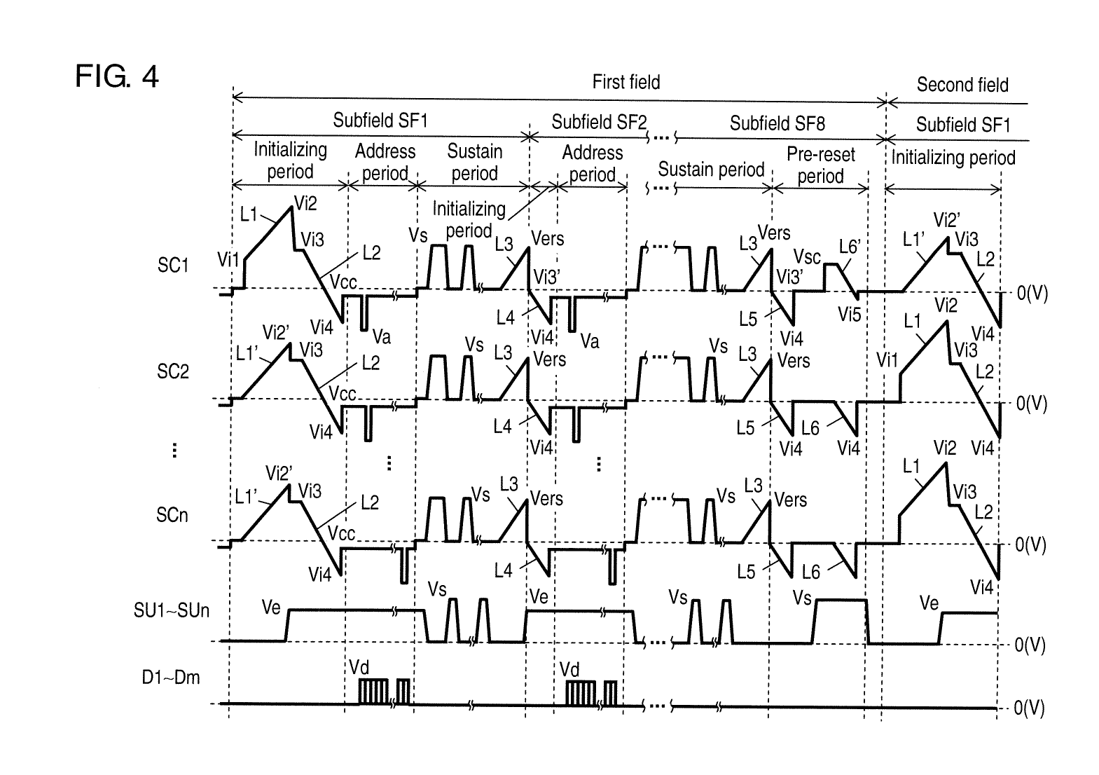

FIG. 4 is a waveform diagram showing one example of a driving voltage waveform to be applied to each electrode of panel 10 used in the plasma display apparatus in accordance with the exemplary embodiment of the present invention. FIG. 4 shows driving voltage waveforms applied to scan electrode SC1 where the address operation is firstly performed in the address period, scan electrode SCn (e.g. scan electrode SC1080) where the address operation is finally performed in the address period, sustain electrode SU1 through sustain electrode SUn, and data electrode D1 through data electrode Dm, respectively. FIG. 4 shows the following driving voltage waveforms. FIG. 4 shows the initializing periods of subfield SF1 of the first field and subfield SF1 of the second field as specific-cell initializing subfields, the initializing period and address period of subfield SF2 as a selective initializing subfield, and the sustain period and pre-reset period of subfield SF8 as the final subfield. Therefore, the waveform of the driving voltage applied to scan electrodes 22 in the initializing period differs between subfield SF1 and subfield SF2 through subfield SF8.

Though the range from the address period of subfield SF2 to the address period of subfield SF8 is not shown, the subfields other than subfield SF1 are selective initializing subfields, and substantially the same driving voltage waveform is generated in each period except for the number of generated sustain pulses. Though the address period and sustain period of subfield SF1 of the second field are not shown, the driving voltage waveform generated in the address period and sustain period of subfield SF1 of the first field is substantially the same as that in the address period and sustain period of subfield SF1 of the second field.

Scan electrode SCi, sustain electrode SUi, and data electrode Dk described later are electrodes selected from respective types of electrodes based on the subfield data (indicating light emission and no light emission in each subfield).

First, subfield SF1 of the first field, which is the specific-cell initializing subfield, is described.

In the present exemplary embodiment, as discussed above, in the specific-cell initializing subfield (subfield SF1) of the first field, a forced initializing waveform for performing a forced initializing operation is applied to an odd-numbered scan electrode from the upside in view of the layout, namely scan electrode SC(1+2×N) (N is an integer of 0 or larger) as the (1+2×N)-th scan electrode. A selective initializing waveform for performing a selective initializing operation is applied to an even-numbered scan electrode from the upside in view of the layout, namely scan electrode SC(2+2×N) as the (2+2×N)-th scan electrode.

In the first half of the initializing period of subfield SF1, voltage 0 (V) is applied to data electrode D1 through data electrode Dm and sustain electrode SU1 through sustain electrode SUn. To scan electrode SC(1+2×N), voltage Vi1 is applied and then a ramp voltage, which gently (at a gradient of about 1.3 V/μsec, for example) increases from voltage Vi1 to voltage Vi2, is applied. This ramp voltage is hereinafter referred to as “up-ramp voltage L1”. At this time, voltage Vi1 is set at a voltage lower than the discharge start voltage with respect to sustain electrode SU(1+2×N), and voltage Vi2 is set at a voltage exceeding the discharge start voltage with respect to sustain electrode SU(1+2×N).

While up-ramp voltage L1 increases, feeble initializing discharge continuously occurs between scan electrode SC(1+2×N) and sustain electrode SU(1+2×N), and feeble initializing discharge continuously occurs between scan electrode SC(1+2×N) and data electrode D1 through data electrode Dm. Then, negative-polarity wall voltage is accumulated on scan electrode SC(1+2×N), and positive-polarity wall voltage is accumulated on sustain electrode SU(1+2×N) and data electrode D1 through data electrode Dm crossing scan electrode SC(1+2×N). The wall voltage on each electrode means voltage generated by the wall charge accumulated on the dielectric layer for covering the electrode, the protective layer, or the phosphor layers.

In the latter half of the initializing period of subfield SF1, the voltage applied to scan electrode SC(1+2×N) is decreased from voltage Vi2 to voltage Vi3 lower than voltage Vi2. Positive-polarity voltage Ve is applied to sustain electrode SU1 through sustain electrode SUn, and voltage 0 (V) is applied to data electrode D1 through data electrode Dm. Ramp voltage, which gently (at a gradient of about −1.0 V/μsec, for example) decreases from voltage Vi3 to negative-polarity voltage Vi4, is applied to scan electrode SC(1+2×N). This ramp voltage is hereinafter referred to as “down-ramp voltage L2”. At this time, voltage Vi3 is set at a voltage lower than the discharge start voltage with respect to sustain electrode SU(1+2×N), and voltage Vi4 is set at a voltage exceeding the discharge start voltage with respect to sustain electrode SU(1+2×N).

While down-ramp voltage L2 is applied to scan electrode SC(1+2×N), feeble initializing discharge occurs between scan electrode SC(1+2×N) and sustain electrode SU(1+2×N), and feeble initializing discharge occurs between scan electrode SC(1+2×N) and data electrode D1 through data electrode Dm. Then, the negative-polarity wall voltage on scan electrode SC(1+2×N) and the positive-polarity wall voltage on sustain electrode SU(1+2×N) are reduced, and the positive-polarity wall voltage on data electrode D1 through data electrode Dm crossing scan electrode SC(1+2×N) is adjusted to a value appropriate for the address operation in the address period.

The above-mentioned voltage waveform is a forced initializing waveform for causing the initializing discharge in a discharge cell regardless of the operation of the immediately preceding subfield. The operation of applying the forced initializing waveform to scan electrodes 22 is a forced initializing operation.

While, in the first half of the initializing period of subfield SF1, not voltage Vi1, but up-ramp voltage L1′, which gently increases from voltage 0 (V) to voltage Vi2′, is applied to scan electrode SC(2+2×N). Up-ramp voltage L1′ has the same gradient as that of up-ramp voltage L1, and has a voltage waveform that continuously increases for the same time as that of up-ramp voltage L1. Therefore, voltage Vi2′ is equal to the voltage derived by subtracting voltage Vi1 from voltage Vi2. At this time, each voltage and up-ramp voltage L1' are set so that voltage Vi2′ is lower than the discharge start voltage with respect to sustain electrodes 23. Therefore, discharge does not substantially occur in the discharge cell to which up-ramp voltage L1′ has been applied.

In the latter half of the initializing period of subfield SF1, down-ramp voltage L2 is applied to scan electrode SC(2+2×N), similarly to scan electrode SC(1+2×N).

The above-mentioned voltage waveform is a selective initializing waveform that is applied to scan electrode SC(2+2×N) in subfield SF1 of the first field.

Thus, the initializing operation in the specific-cell initializing subfield (subfield SF1) of the first field is completed.

Detailed description is omitted in this paragraph. In the specific-cell initializing subfield (subfield SF1) of the second field, a forced initializing waveform for performing a forced initializing operation is applied to an even-numbered scan electrode from the upside in view of the layout, namely scan electrode SC(2+2×N) as the (2+2×N)-th scan electrode. A selective initializing waveform for performing a selective initializing operation is applied to an odd-numbered scan electrode from the upside in view of the layout, namely scan electrode SC(1+2×N) as the (1+2×N)-th scan electrode. In other words, in the specific-cell initializing subfield of the second field, a forced initializing operation is performed in the discharge cell having undergone the selective initializing operation in the specific-cell initializing subfield of the first field, and a selective initializing operation is performed in the discharge cell having undergone the forced initializing operation in the specific-cell initializing subfield of the first field.

In the subsequent address period, an address operation is performed where scan pulses are applied to scan electrodes 22, address pulses are selectively applied to data electrodes 32, address discharge is selectively caused in the discharge cell to emit light, and wall charge for causing sustain discharge in the subsequent sustain period is produced in the discharge cell.

In the address period of subfield SF1, voltage Ve is applied to sustain electrode SU1 through sustain electrode SUn, and voltage Vcc (voltage Va+voltage Vsc, for example) is applied to each of scan electrode SC1 through scan electrode SCn.

Next, a scan pulse of negative-polarity voltage Va is applied to first scan electrode SC1 (first row) from the upside in view of the layout. Then, an address pulse of positive-polarity voltage Vd is applied to data electrode Dk in the discharge cell to emit light in the first row, of data electrode Dl through data electrode Dm.

The voltage difference in the intersecting part of data electrode Dk and scan electrode SC1 in the discharge cell to which the address pulse of voltage Vd has been applied is derived by adding the difference between the wall voltage on data electrode Dk and that on scan electrode SC1 to the difference (voltage Vd−voltage Va) of the external applied voltage. Thus, the voltage difference between data electrode Dk and scan electrode SC1 exceeds the discharge start voltage, and discharge occurs between data electrode Dk and scan electrode SC1.

Since voltage Ve is applied to sustain electrode SU1 through sustain electrode SUn, the voltage difference between sustain electrode SU1 and scan electrode SC1 is derived by adding the difference between the wall voltage on sustain electrode SU1 and that on scan electrode SC1 to the difference (voltage Ve−voltage Va) of the external applied voltage. At this time, by setting voltage Ve at a voltage value slightly lower than the discharge start voltage, a state where discharge does not occur but is apt to occur can be caused between sustain electrode SU1 and scan electrode SC1.

Therefore, the discharge occurring between data electrode Dk and scan electrode SC1 can cause discharge between sustain electrode SU1 and scan electrode SC1 that exist in a region crossing data electrode Dk. Thus, address discharge occurs in the discharge cell to emit light, positive-polarity wall voltage is accumulated on scan electrode SC1, negative-polarity wall voltage is accumulated on sustain electrode SU1, and negative-polarity wall voltage is also accumulated on data electrode Dk.

Thus, the address operation of causing address discharge in the discharge cell to emit light in the first row and accumulating wall voltage on each electrode is performed. While, the voltage in the part where scan electrode SC1 intersects with data electrode 32 to which no address pulse has been applied does not exceed the discharge start voltage, so that address discharge does not occur.

This address operation is performed sequentially in the order of scan electrode SC2, scan electrode SC3, . . . , and scan electrode SCn until it reaches the discharge cell in the n-th row, and the address period in subfield SF1 is completed. Thus, in the address period, address discharge is selectively caused in the discharge cell to emit light, and wall charge is formed in the discharge cell.

In the sustain period, a sustain operation is performed where as many sustain pulses as the number derived by multiplying the luminance weight of each subfield by a predetermined proportionality constant are alternately applied to scan electrodes 22 and sustain electrodes 23, sustain discharge is caused in the discharge cell having undergone address discharge in the immediately preceding address period, and light is emitted in the discharge cell. This proportionality constant is luminance magnification. For example, when the luminance magnification is two, four sustain pulses are applied to scan electrodes 22 and four sustain pulses are applied to sustain electrodes 23 in the sustain period of the subfield of luminance weight “2”. Therefore, the number of sustain pulses generated in the sustain period is eight.

In the sustain period in subfield SF1, voltage 0 (V) as base potential is applied to sustain electrode SU1 through sustain electrode SUn, and a sustain pulse of positive-polarity voltage Vs is applied to scan electrode SC1 through scan electrode SCn. In the discharge cell having undergone address discharge, the voltage difference between scan electrode SCi and sustain electrode SUi is obtained by adding the difference between the wall voltage on scan electrode SCi and that on sustain electrode SUi to voltage Vs of the sustain pulse.

Thus, the voltage difference between scan electrode SCi and sustain electrode SUi exceeds the discharge start voltage, and sustain discharge occurs between scan electrode SCi and sustain electrode SUi. Ultraviolet rays generated by this discharge cause phosphor layer 35 to emit light. By this discharge, negative-polarity wall voltage is accumulated on scan electrode SCi, and positive-polarity wall voltage is accumulated on sustain electrode SUi. Positive-polarity wall voltage is also accumulated on data electrode Dk. In the discharge cell having undergone no address discharge in the address period, sustain discharge does not occur and the wall voltage at the end of the initializing period is kept.

Subsequently, voltage 0 (V) is applied to scan electrode SC1 through scan electrode SCn, and sustain pulses of voltage Vs are applied to sustain electrode SU1 through sustain electrode SUn. In the discharge cell having undergone the sustain discharge, the voltage difference between sustain electrode SUi and scan electrode SCi exceeds the discharge start voltage. Thus, sustain discharge occurs between sustain electrode SUi and scan electrode SCi again, negative-polarity wall voltage is accumulated on sustain electrode SUi, and positive-polarity wall voltage is accumulated on scan electrode SCi.

Hereinafter, similarly, as many sustain pulses as the number derived by multiplying the luminance weight by a predetermined luminance magnification are alternately applied to scan electrode SC1 through scan electrode SCn and sustain electrode SU1 through sustain electrode SUn. Thus, by applying the potential difference between the electrodes of display electrode pair 24, sustain discharge is continuously performed in the discharge cell having undergone the address discharge in the address period.

After generation of sustain pulses in the sustain period (end of the sustain period), in the state where voltage 0 (V) is applied to sustain electrode SU1 through sustain electrode SUn and data electrode D1 through data electrode Dm, ramp voltage, which gently (at a gradient of about 10 V/μsec, for example) increases from voltage 0 (V) as base potential to voltage Vers, is applied to scan electrode SC1 through scan electrode SCn. This ramp voltage is hereinafter referred to as “erasing ramp voltage L3”.

By setting voltage Vers at a voltage exceeding the discharge start voltage, feeble discharge continuously occurs between sustain electrode SUi and scan electrode SCi of the discharge cell having undergone sustain discharge while erasing ramp voltage L3 applied to scan electrode SC1 through scan electrode SCn increases beyond the discharge start voltage. Charged particles generated by the feeble discharge are accumulated as wall charge on sustain electrode SUi and scan electrode SCi so as to reduce the voltage difference between sustain electrode SUi and scan electrode SCi. Therefore, the wall voltage on scan electrode SCi and that of sustain electrode SUi are reduced to the difference between the voltage applied to scan electrode SCi and the discharge start voltage, for example, the degree of (voltage Vers−discharge start voltage), while the positive-polarity wall voltage is left on data electrode Dk. This discharge is hereinafter referred to as “erasing discharge”.

When the voltage applied to scan electrode SC1 through scan electrode SCn arrives at voltage Vers, the applied voltage to scan electrode SC1 through scan electrode SCn is decreased to voltage 0 (V). Thus, the sustain operation in the sustain period in subfield SF1 is completed.

Thus, the driving operation of subfield SF1 is completed.

Next, the selective initializing subfield is described while subfield SF2 is taken as an example.

In the initializing period of subfield SF2, a selective initializing waveform is applied to all scan electrodes 22. This selective initializing waveform is a driving voltage waveform where the first half of the forced initializing waveform is omitted. Specifically, voltage Ve is applied to sustain electrode SU1 through sustain electrode SUn, and voltage 0 (V) is applied to data electrode D1 through data electrode Dm. Down-ramp voltage L4, which decreases from voltage (e.g. voltage 0 (V)) lower than the discharge start voltage to negative-polarity voltage Vi4 exceeding the discharge start voltage at the same gradient as that of down-ramp voltage L2, is applied to scan electrode SC1 through scan electrode SCn.

Feeble initializing discharge occurs in the discharge cell having undergone the sustain discharge in the sustain period of the immediately preceding subfield (subfield SF1 in FIG. 4). Then, the wall voltages on scan electrode SCi and sustain electrode SUi are reduced. Since sufficient positive-polarity wall voltage is accumulated on data electrode Dk by sustain discharge occurring in the immediately preceding sustain period, the excessive part of this wall voltage is discharged, and the wall voltage on data electrode Dk is adjusted to the wall voltage suitable for the address operation.

In the discharge cell having undergone no sustain discharge in the sustain period of the immediately preceding subfield (subfield SF1 in FIG. 4), initializing discharge does not occur, and the wall charge at the end of the initializing period of the immediately preceding subfield is kept as it is.

The above-mentioned waveform is a selective initializing waveform for causing initializing discharge only in the discharge cell having undergone sustain discharge in the sustain period of the immediately preceding subfield. Then, the operation of applying the selective initializing waveform to scan electrodes 22 is a selective initializing operation.

Thus, the selective initializing operation in the initializing period of the selective initializing subfield is completed.

The selective initializing waveform generated in the initializing period of subfield SF1 and the selective initializing waveform generated in the initializing period of subfield SF2 have different shapes. In the selective initializing waveform generated in the initializing period of subfield SF1, discharge does not occur in the first half of the initializing period, and the operation of the latter half of the initializing period is substantially the same as the selective initializing operation in the initializing period of subfield SF2. Therefore, in the present exemplary embodiment, the initializing waveform that is generated in the initializing period of subfield SF1 and has up-ramp voltage L1′ and down-ramp voltage L2 is set as the selective initializing waveform.

In the address period of subfield SF2, an address operation of applying, to each electrode, the same driving voltage waveform as that in the address period of subfield SF1 and accumulating wall voltage on each electrode of the discharge cell to emit light is performed.

In the sustain period of subfield SF2, similarly to the sustain period of subfield SF1, as many sustain pulses as the number corresponding to the luminance weight are alternately applied to scan electrode SC1 through scan electrode SCn and sustain electrode SU1 through sustain electrode SUn, and sustain discharge is caused in the discharge cell having undergone the address discharge in the address period.

In the initializing period and address period of each of subfield SF3 and later, a driving voltage waveform similar to that in the initializing period and address period of subfield SF2 is applied to each electrode. In the sustain period of each of subfield SF3 and later, a driving voltage waveform similar to that in subfield SF2 is applied to each electrode except for the number of generated sustain pulses.

In the present exemplary embodiment, a pre-reset period is disposed after the sustain period in the subfield immediately before the specific-cell initializing subfield. This subfield is subfield SF8 as the final subfield of one field in the present exemplary embodiment.

This pre-reset period has a function of stabilizing the initializing operation in subfield SF1 of the subsequent field. In the pre-reset period, a first ramp voltage (hereinafter referred to as “down-ramp voltage L5”) is applied to scan electrodes 22, and then one of second ramp voltage (hereinafter referred to as “down-ramp voltage L6”) and third ramp voltage (hereinafter referred to as “down-ramp voltage L6”) is applied to scan electrodes 22.

Specifically, erasing ramp voltage L3 is applied to scan electrodes 22, and then voltage 0 (V) is applied to sustain electrodes 23 and data electrodes 32. Then, down-ramp voltage L5 (first ramp voltage), which decreases from voltage 0 (V) to negative-polarity voltage Vi4 at the same gradient as that of down-ramp voltage L2, is applied to scan electrodes 22. Here, the gradient is about −1.0 V/μsec, for example.

By setting voltage Vi4 at a voltage exceeding the discharge start voltage with respect to data electrodes 32, feeble discharge as first auxiliary discharge occurs between scan electrodes 22 and data electrodes 32 of the discharge cell having undergone sustain discharge in the sustain period immediately before the pre-reset period, namely of the discharge cell having undergone sustain discharge in the sustain period of subfield SF8. At this time, this discharge occurs between facing electrodes, and hence becomes counter discharge.

After down-ramp voltage L5 is applied to scan electrodes 22, the applied voltage to scan electrodes 22 is returned to voltage 0 (V) and positive-polarity voltage (voltage Vs in FIG. 4) is applied to sustain electrodes 23.

Then, down-ramp voltage L6 (second ramp voltage), which decreases from voltage 0 (V) to negative-polarity voltage Vi4 at the same gradient as that of down-ramp voltage L2, is applied to scan electrode 22 to which a forced initializing waveform is applied in the initializing period of subsequent subfield SF1. Here, scan electrode 22 is scan electrode SC(2+2×N) in the example of FIG. 4, and the gradient is about −1.0 V/μsec, for example. In other words, positive-polarity voltage Vs is applied to sustain electrode 23 and down-ramp voltage L6 is applied to scan electrode 22 in the discharge cell where a forced initializing operation is performed in the initializing period of the specific-cell initializing subfield immediately after the pre-reset period.

By setting voltage Vi4 at a voltage exceeding the discharge start voltage with respect to sustain electrodes 23, feeble discharge as the second auxiliary discharge occurs in the discharge cell formed on scan electrode SC(2+2×N). Thus, priming particles can be generated in the discharge cell, positive-polarity wall voltage can be formed on scan electrode SC(2+2×N), and negative-polarity wall voltage can be formed on sustain electrode SU(2+2×N). By applying voltage Vs to sustain electrodes 23, the second auxiliary discharge can be caused even in the discharge cell having undergone the first auxiliary discharge.

Positive-polarity voltage (voltage Vs in FIG. 4) that is applied to sustain electrodes 23 while down-ramp voltage L6 is applied to scan electrodes 22 is higher than the positive-polarity voltage (voltage Ve in FIG. 4) applied to sustain electrodes 23 in the selective initializing period.

Voltage (voltage 0 (V) in FIG. 4) that is applied to sustain electrodes 23 while down-ramp voltage L5 is applied to scan electrodes 22 is lower than the positive-polarity voltage applied to sustain electrodes 23 while down-ramp voltage L6 is applied to scan electrodes 22. FIG. 4 shows the example where this voltage is voltage 0 (V). However, this voltage is not limited to voltage 0 (V), but may be negative-polarity voltage such as several volts (e.g. about −10 V/μsec)

While, voltage Vsc as a predetermined positive-polarity voltage is applied to scan electrode 22 to which the selective initializing waveform is applied in the initializing period of subsequent subfield SF1. Here, scan electrode 22 is scan electrode SC(1+2×N) in the example of FIG. 4. Then, down-ramp voltage L6′ (third ramp voltage), which decreases from voltage Vsc to voltage Vi5 at the same gradient as that of down-ramp voltage L6 for the same period as that of down-ramp voltage L6, is applied to scan electrode 22. Voltage Vi5 becomes equal to the voltage obtained by adding negative-polarity voltage Vi4 to voltage Vsc, and hence becomes higher than voltage Vi4 as the minimum voltage of down-ramp voltage L6. By setting each voltage and down-ramp voltage L6′ so that voltage Vi5 becomes lower than the discharge start voltage, discharge substantially does not occur in the discharge cell (formed on scan electrode SC(2+2×N) in the example of FIG. 4) to which down-ramp voltage L6′ has been applied.

The driving voltage waveform applied to each electrode of panel 10 of the present exemplary embodiment has been described schematically.

Next, in the present exemplary embodiment, the reason why down-ramp voltage L5 and down-ramp voltage L6 or down-ramp voltage L6′ are generated and applied to scan electrodes 22 in the pre-reset period is described.

The reason why down-ramp voltage L5 is generated and applied to scan electrodes 22 in the pre-reset period is described below.

For example, the following phenomenon is recognized: when the period from the erasing operation by erasing ramp voltage L3 in the final subfield of the first field to the initializing period of subfield SF1 of the subsequent second field is extended, initializing discharge by down-ramp voltage L2 becomes unstable in the discharge cell where the selective initializing operation is performed in the specific-cell initializing period of subfield SF1. This phenomenon occurs similarly in the case where the period from the erasing operation by erasing ramp voltage L3 in the final subfield of the second field to the initializing period of subfield SF1 of the subsequent first field is extended.

This is considered to be because the wall charge adjusted by the erasing discharge decreases with the passage of time and the initializing discharge hardly occurs. When the initializing discharge becomes unstable, the wall discharge is not initialized appropriately and the address operation in the subsequent address period becomes unstable. In the discharge cell where the forced initializing operation is performed, however, the initializing discharge by up-ramp voltage L1 occurs and hence this phenomenon does not occur.

For example, in order to stably cause initializing discharge in the discharge cell where the selective initializing operation is performed in subfield SF1 of the second field, it is preferable that the period from the erasing operation by erasing ramp voltage L3 in the first field to the selective initializing operation of subfield SF1 of the second field is minimized. Similarly, in order to stably cause initializing discharge in the discharge cell where the selective initializing operation is performed in subfield SF1 of the first field, it is preferable that the period from the erasing operation by erasing ramp voltage L3 in the second field to the selective initializing operation of subfield SF1 of the first field is minimized. In the present exemplary embodiment, however, the time for generating up-ramp voltage L1 for the forced initializing operation and the time for generating down-ramp voltage L6 (or down-ramp voltage L6′) are required.

Then, in the present exemplary embodiment, after the erasing operation by erasing ramp voltage L3, down-ramp voltage L5 is applied to scan electrodes 22. Thus, feeble discharge (counter discharge) occurs between scan electrode 22 and data electrode 32 in the discharge cell having undergone sustain discharge in the sustain period of subfield SF8.

This discharge has a function similar to that of the initializing discharge. Therefore, due to this discharge, the positive-polarity wall voltage on data electrode 32 is adjusted to a value appropriate for address operation, and the wall charge in the discharge cell becomes more stable than that in the discharge cell after occurrence of the erasing discharge. The priming particles in the discharge cell are also adjusted to a state appropriate for occurrence of discharge. Therefore, stable initializing discharge occurs in the discharge cell where the selective initializing operation is performed in the specific-cell initializing period of subfield SF1 of the second field following subfield SF8 of the first field, and in the discharge cell where the selective initializing operation is performed in the specific-cell initializing period of subfield SF1 of the first field following subfield SF8 of the second field. At this time, the counter discharge by down-ramp voltage L5 has already occurred, so that the counter discharge does not occur and only discharge between scan electrode 22 and sustain electrode 23 occurs. This discharge is plane discharge because the discharge occurs between parallel electrodes.

Thus, by causing discharge by down-ramp voltage L5 after the erasing operation by erasing ramp voltage L3, the address operation in the address period of subfield SF1 can be stably caused even when the period from the erasing operation by erasing ramp voltage L3 to the selective initializing operation of subfield SF1 is extended.

The reason why down-ramp voltage L6 is generated in the pre-reset period and applied to the discharge cell where the forced initializing operation is performed in the initializing period of subsequent subfield SF1 is described below.

It is recognized that the discharge delay increases when the xenon partial pressure of the discharge gas in panel 10 is increased in order to increase the luminous efficiency. This discharge delay means the period after the voltage applied to the discharge cell exceeds the discharge start voltage until discharge occurs actually. For example, if the discharge delay is large when up-ramp voltage L1 is applied to scan electrode 22 and the forced initializing operation is performed, the value of up-ramp voltage L1 increases significantly in the period after the voltage applied to the discharge cell exceeds the discharge start voltage until discharge occurs actually. Therefore, strong discharge (hereinafter referred to as “strong discharge”) can occur in the discharge cell.

When strong discharge occurs, excessive wall charge and priming particles are formed in the discharge cell, hence false discharge is caused in the subsequent address period, and sustain discharge can occur to generate a discharge cell to emit light in the subsequent sustain period though no address has been performed.

Discharge caused by down-ramp voltage L6 has a function of preventing the strong discharge from occurring. The discharge caused by down-ramp voltage L6 can generate priming particles in the discharge cell and can adjust the wall charge to an appropriate state, as discussed above. Thus, the discharge delay in the subsequent forced initializing operation can be improved. In other words, strong discharge can be prevented from occurring when the initializing discharge is caused by up-ramp voltage L1.

The reason why down-ramp voltage L6′ is generated in the pre-reset period and applied to the discharge cell where the selective initializing operation is performed in the initializing period of subsequent subfield SF1 is described below.

In the discharge cell where the selective initializing operation is performed in the initializing period of subfield SF1, initializing discharge is not caused by up-ramp voltage L1 and hence discharge by down-ramp voltage L6 is unnecessary. Rather, preferably, unnecessary discharge is not caused and the state of the wall charge adjusted by the discharge by down-ramp voltage L5 is not damaged.

Voltage Vsc is applied to scan electrode 22 (scan electrode SC(1+2×N) in the example of FIG. 4) to which a selective initializing waveform is applied in the initializing period of subsequent subfield SF1. Thus, the voltage applied to scan electrode 22 becomes down-ramp voltage L6′, which decreases from voltage Vsc to voltage Vi5 that does not exceed the discharge start voltage with respect to sustain electrode 23. Therefore, in the discharge cell formed on scan electrode 22, no discharge occurs and the state of the wall charge adjusted by the discharge by down-ramp voltage L5 can be kept.

Thus, in the present exemplary embodiment, a pre-reset period is disposed after the completion of the sustain period of the final subfield, down-ramp voltage L5 is applied to all discharge cells in the pre-reset period, then down-ramp voltage L6 is applied to the discharge cell where the forced initializing operation is performed in the initializing period of subfield SF1 of the subsequent field, and down-ramp voltage L6′ is applied to the discharge cell where the selective initializing operation is performed in the initializing period of subfield SF1 of the subsequent field. Thus, stable initializing operation can be performed in the initializing period of subfield SF1.

In the present exemplary embodiment, the voltage values applied to respective electrodes are set as follows: voltage Vi1 is 147 (V), voltage Vi2 is 357 (V), voltage Vi2′ is 210 (V), voltage Vi3 is 210 (V), voltage Vi4 is −160 (V), voltage Ve is 125 (V), voltage Vers is 210 (V), voltage Vsc is 147 (V), voltage Vs is 210 (V), voltage Va is −185 (V), and voltage Vd is 60 (V). Voltage Vcc can be generated by adding positive-polarity voltage Vsc (147 (V)) to negative-polarity voltage Va (−185 (V)) (Vcc=Va+Vsc), and voltage Vcc is −38 (V) at this time. Voltage Vi5 is generated by adding voltage Vi4 (−160 (V)) to voltage Vsc (147 (V)) (Vi5=Vsc+Vi4), and hence voltage Vi5 is −13 (V) at this time.

The specific numerical values of the voltage values and gradients are simply one example, and the voltage values and gradients of the present invention are not limited to the above-mentioned numerical values. Preferably, the voltage values and gradients are set at optimal values based on the discharge characteristics of the panel and the specification of the plasma display apparatus.

In the present exemplary embodiment, the voltage that is applied to scan electrode 22 in the pre-reset period is not limited to down-ramp voltage L6′. Here, to scan electrode 22, a selective initializing waveform is applied in the initializing period of the subsequent subfield SF1. This voltage is not necessarily down-ramp voltage L6′ as long as no discharge occurs in the discharge cell. For example, instead of down-ramp voltage L6′, voltage 0 (V) may be applied.

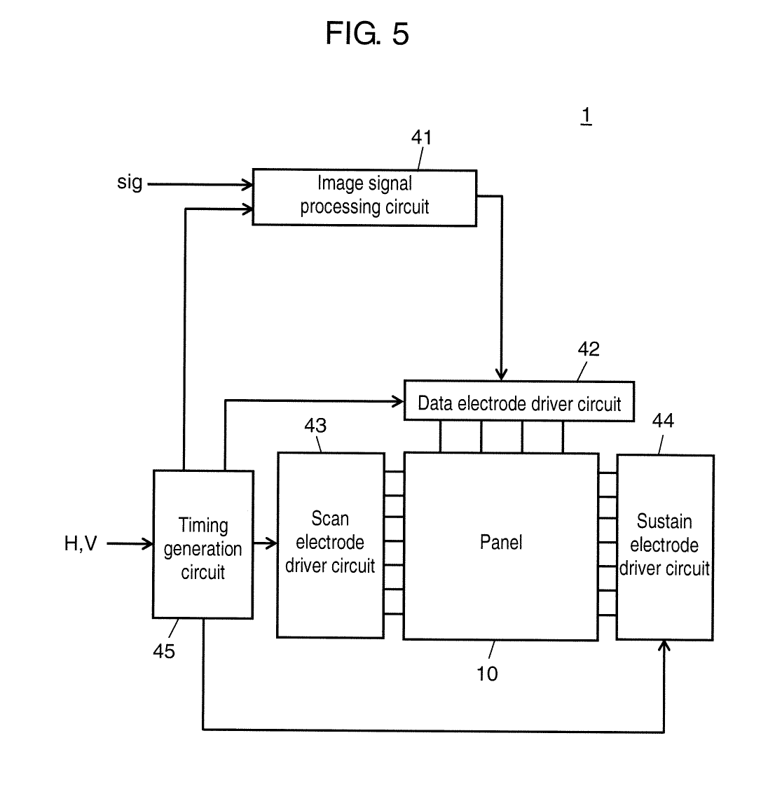

Next, the configuration of the plasma display apparatus of the present exemplary embodiment is described. FIG. 5 is a circuit block diagram of plasma display apparatus 1 in accordance with the exemplary embodiment of the present invention. Plasma display apparatus 1 includes panel 10 and a driver circuit.

The driver circuit includes the following elements:
image signal processing circuit 41;
data electrode driver circuit 42;
scan electrode driver circuit 43;
sustain electrode driver circuit 44;
timing generation circuit 45; and
a power supply circuit (not shown) for supplying power required for each circuit block.

Image signal processing circuit 41 assigns a gradation value to each discharge cell based on the number of pixels of panel 10 and input image signal sig. Then, image signal processing circuit 41 converts the gradation value into subfield data indicating light emission and no light emission in each subfield. In this subfield data, light emission and no light emission correspond to digital signals, “1” and “0”. In other words, image signal processing circuit 41 converts the image signal in each field into subfield data indicating the light emission and no light emission in each subfield.

For example, when the input image signal includes an R signal, a G signal, and a B signal, image signal processing circuit 41 assigns each gradation value of R, G, and B to each discharge cell based on the R signal, the G signal, and the B signal. When the input image signal includes a luminance signal (Y signal) and a chroma signal (C signal, R-Y signal and B-Y signal, or u signal and v signal), image signal processing circuit 41 calculates the R signal, the G signal, and the B signal based on the luminance signal and chroma signal, and then assigns each gradation value (gradation value represented in one field) of R, G, and B to each discharge cell. Image signal processing circuit 41 converts each gradation value of R, G, and B assigned to each discharge cell into subfield data that indicates light emission or no light emission in each subfield.

Timing generation circuit 45 generates various timing signals for controlling operations of respective circuit blocks based on horizontal synchronizing signal H and vertical synchronizing signal V. Timing generation circuit 45 supplies the generated timing signals to respective circuit blocks (image signal processing circuit 41, data electrode driver circuit 42, scan electrode driver circuit 43, and sustain electrode driver circuit 44).

Data electrode driver circuit 42 converts subfield data in each subfield into a signal corresponding to each of data electrode D1 through data electrode Dm. Data electrode driver circuit 42 drives each of data electrode D1 through data electrode Dm based on the converted signal and the timing signal supplied from timing generation circuit 45. Data electrode driver circuit 42 generates an address pulse and applies it to each of data electrode D1 through data electrode Dm in the address period.

Scan electrode driver circuit 43 has an initializing waveform generation circuit, a sustain pulse generation circuit, and a scan pulse generation circuit (not shown). Scan electrode driver circuit 43 generates a driving voltage waveform based on a timing signal supplied from timing generation circuit 45, and applies it to each of scan electrode SC1 through scan electrode SCn.

The initializing waveform generation circuit generates an initializing waveform to be applied to scan electrode SC1 through scan electrode SCn based on the timing signal in the initializing period.

The sustain pulse generation circuit generates a sustain pulse to be applied to scan electrode SC1 through scan electrode SCn based on the timing signal in the sustain period.

The scan pulse generation circuit has a plurality of scan electrode driver ICs (hereinafter referred to as “scan ICs”), and generates a scan pulse to be applied to scan electrode SC1 through scan electrode SCn based on the timing signal in the address period.

Sustain electrode driver circuit 44 has a sustain pulse generation circuit and a circuit (not shown in FIG. 5) for generating voltage Ve. Sustain electrode driver circuit 44 generates a driving voltage waveform based on the timing signal supplied from timing generation circuit 45, and applies it to each of sustain electrode SU1 through sustain electrode SUn. Sustain electrode driver circuit 44 generates a sustain pulse based on the timing signal and applies it to sustain electrode SU1 through sustain electrode SUn in the sustain period.

Next, the details and operation of scan electrode driver circuit 43 are described.

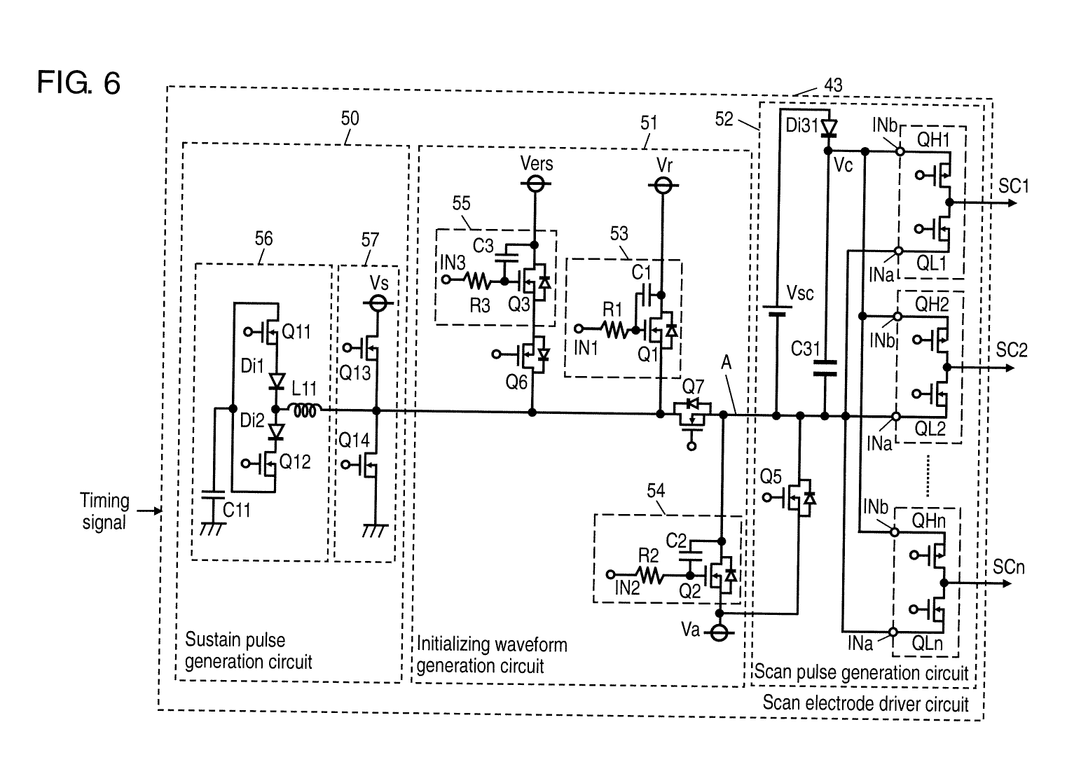

FIG. 6 is a circuit diagram showing one configuration example of scan electrode driver circuit 43 in accordance with the exemplary embodiment of the present invention. Scan electrode driver circuit 43 has sustain pulse generation circuit 50 for generating a sustain pulse, initializing waveform generation circuit 51 for generating an initializing waveform, and scan pulse generation circuit 52 for generating a scan pulse. Then, each output terminal of scan pulse generation circuit 52 is connected to each of scan electrode SC1 through scan electrode SCn of panel 10.

In the present exemplary embodiment, the voltage to be input to scan pulse generation circuit 52 is referred to as “reference potential A”. In the following description, an operation of conducting a switching element is denoted as “ON”, and an operation of blocking it is denoted as “OFF”. A signal for setting the switching element at ON is denoted as “Hi”, and a signal for setting it at OFF is denoted as “Lo”. In FIG. 6, the details of a signal path of a control signal (timing signal supplied from timing generation circuit 45) input to each circuit are omitted.

FIG. 6 shows a separating circuit using switching circuit Q7. Switching circuit Q7 electrically separates a circuit (e.g. Miller integrating circuit 54) using negative-polarity voltage Va from sustain pulse generation circuit 50, a circuit (e.g. Miller integrating circuit 53) using voltage Vr, and a circuit (e.g. Miller integrating circuit 55) using voltage Vers while the circuit using voltage Va is operating. FIG. 6 shows a separating circuit using switching circuit Q6 that electrically separates a circuit (e.g. Miller integrating circuit 53) using voltage Vr from a circuit (e.g. Miller integrating circuit 55) using voltage Vers lower than voltage Vr while the circuit using voltage Vr is operating.

Sustain pulse generation circuit 50 includes power recovery circuit 56 and clamping circuit 57.

Power recovery circuit 56 has capacitor C11 for power recovery, switching element Q11, switching element Q12, diode Di1 and diode Di2 for back flow prevention, and inductor L11 for resonance. Capacitor C11 for power recovery has a capacity sufficiently larger than inter-electrode capacity Cp, and is charged to about Vs/2, namely a half voltage value Vs, so as to serve as a power supply of power recovery circuit 56.

Clamping circuit 57 has switching element Q13 for clamping scan electrode SC1 through scan electrode SCn on voltage Vs and switching element Q14 for clamping scan electrode SC1 through scan electrode SCn on voltage 0 (V). Then, clamping circuit 57 generates a sustain pulse while switching between the switching elements based on the timing signal output from timing generation circuit 45.

For example, in raising a sustain pulse, clamping circuit 57 sets switching element Q11 at ON to resonate inter-electrode capacity Cp and inductor L11, and supplies electric power accumulated in capacitor C11 for power recovery to scan electrode SC1 through scan electrode SCn via switching element Q11, diode Di1, and inductor L11. When the voltage of scan electrode SC1 through scan electrode SCn approaches voltage Vs, clamping circuit 57 sets switching element Q13 at ON, and clamps scan electrode SC1 through scan electrode SCn on voltage Vs.

In falling a sustain pulse, clamping circuit 57 sets switching element Q12 at ON to resonate inter-electrode capacity Cp and inductor L11, and recovers electric power in inter-electrode capacity Cp to capacitor C11 for power recovery via inductor L11, diode Di2, and switching element Q12. When the voltage of scan electrode SC1 through scan electrode SCn approaches voltage 0 (V), clamping circuit 57 sets switching element Q14 at ON, and clamps scan electrode SC1 through scan electrode SCn on voltage 0 (V).

Initializing waveform generation circuit 51 has Miller integrating circuit 53, Miller integrating circuit 54, and Miller integrating circuit 55. In FIG. 6, an input terminal of Miller integrating circuit 53 is denoted as input terminal IN1, an input terminal of Miller integrating circuit 54 is denoted as input terminal IN2, and an input terminal of Miller integrating circuit 55 is denoted as input terminal IN3. Miller integrating circuit 53 and Miller integrating circuit 55 generate an increasing ramp voltage, and Miller integrating circuit 54 generates a decreasing ramp voltage.

Miller integrating circuit 53 has switching element Q1, capacitor C1, and resistor R1, and generates up-ramp voltage L1′ by gently (at a gradient of 1.3 V/μsec, for example) increasing reference potential A of scan electrode driver circuit 43 to voltage Vi2′ in a ramp shape during the initializing operation.

Miller integrating circuit 55 has switching element Q3, capacitor C3, and resistor R3, and generates erasing ramp voltage L3 by increasing reference potential A to voltage Vers at a gradient (e.g. 10 V/μsec) steeper than that of up-ramp voltage L1′ at the end of the sustain period.

Miller integrating circuit 54 has switching element Q2, capacitor C2, and resistor R2, and generates down-ramp voltage L2, down-ramp voltage L4, down-ramp voltage L5, and down-ramp voltage L6 by gently (at a gradient of −1.0 V/μsec, for example) decreasing reference potential A to voltage Vi4 in a ramp shape during the initializing operation.

Scan pulse generation circuit 52 has switching element QH1 through switching element QHn and switching element QL1 through switching element QLn for applying a scan pulse to each of n scan electrode SC1 through scan electrode SCn. One terminal of switching element QHj (j is 1 through n) is connected to one terminal of switching element QLj, and the connection part serves as an output terminal of scan pulse generation circuit 52 and is connected to scan electrode SCj. The other terminal of switching element QHj is input terminal INb, and the other terminal of switching element QLj is input terminal INa.

Switching element QH1 through switching element QHn and switching element QL1 through switching element QLn are classified into groups each of which has a plurality of outputs to provide integrated circuits (ICs). These ICs are scan ICs.

Scan pulse generation circuit 52 has the following elements:
switching element Q5 for connecting reference potential A to negative-polarity voltage Va in the address period;
power supply VSC for generating voltage Vsc and adding voltage Vsc to reference potential A; and
diode Di31 and capacitor C31 that apply voltage Vc generated by adding voltage Vsc to reference potential A to input terminal INb.
   Voltage Vc is input to input terminals INb of switching element QH1 through switching element QHn, and reference potential A is input to input terminals INa of switching element QL1 through switching element QLn.

In the address period, scan pulse generation circuit 52 having such a configuration sets switching element Q5 at ON to make reference potential A equal to negative-polarity voltage Va, applies negative-polarity voltage Va to input terminals INa, and applies voltage Vc (voltage Va+voltage Vsc) (voltage Vcc shown in FIG. 4) to input terminals INb. Based on the subfield data, negative-polarity scan pulse voltage Va is applied to scan electrode SCi, to which a scan pulse is applied, via switching element QLi by setting switching element QHi at OFF and setting switching element QLi at ON. Voltage Va+voltage Vsc (voltage Vcc shown in FIG. 4) is applied to scan electrode SCh (h is 1 through n except i), to which no scan pulse is applied, via switching element QHh by setting switching element QLh at OFF and setting switching element QHh at ON.

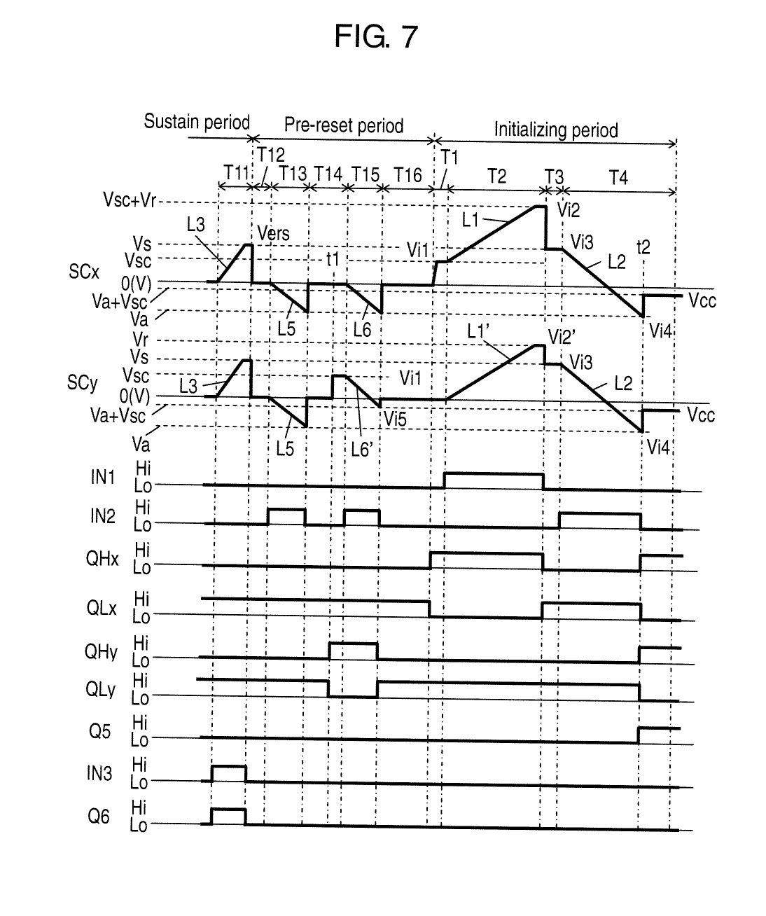

Next, an operation of generating down-ramp voltage L5, down-ramp voltage L6, and down-ramp voltage L6′ in the pre-reset period and generating a forced initializing waveform and a selective initializing waveform in the initializing period of the specific-cell initializing subfield is described using FIG. 7.

FIG. 7 is a timing chart showing one example of an operation of scan electrode driver circuit 43 in the pre-reset period and in the specific-cell initializing period in accordance with the exemplary embodiment of the present invention. In FIG. 7, scan electrode 22 to which a forced initializing waveform is applied is denoted as “scan electrode SCx”, and scan electrode 22 to which a selective initializing waveform is applied is denoted as “scan electrode SCy”

The description of the operation of scan electrode driver circuit 43 when the selective initializing waveform is generated in the selective initializing subfields other than subfield SF1 is omitted. However, the operation of generating down-ramp voltage L4 having a selective initializing waveform is similar to the operation of generating down-ramp voltage L2 shown in FIG. 7. FIG. 7 shows an operation of generating erasing ramp voltage L3.

In FIG. 7, the pre-reset period is divided into five periods denoted as period T12 through period T16, the specific-cell initializing period (initializing period of subfield SF1) is divided into four periods denoted as period T1 through period T4, the period of generating erasing ramp voltage L3 is denoted as period T11, and each period is described. In this description, it is assumed that voltage Vi1 is equal to voltage Vsc, voltage Vi2 is equal to voltage Vsc+voltage Vr, voltage Vi2′ is equal to voltage Vr, voltage Vi3 is equal to voltage Vs used when a sustain pulse is generated, and voltage Vi4 is equal to negative-polarity voltage Va. In FIG. 7, a signal for setting the switching element at ON is denoted as “Hi”, and a signal for setting it at OFF is denoted as “Lo”.

FIG. 7 shows an example where the value of voltage Vs is set to be higher than that of voltage Vsc, but the value of voltage Vs may be equal to that of voltage Vsc or the value of voltage Vs may be lower than that of voltage Vsc.

Hereinafter, the operation in the specific-cell initializing period, the erasing operation, and the operation in the pre-reset period are described in that order.

Before period T1, reference potential A is set at voltage 0 (V) by setting switching element Q13 at OFF and switching element Q14 at ON in clamping circuit 57 of sustain pulse generation circuit 50. Reference potential A, namely voltage 0 (V), is applied to scan electrode SC1 through scan electrode SCn by setting switching element QH1 through switching element QHn at OFF and switching element QL1 through switching element QLn at ON. Miller integrating circuit 55 is electrically separated from reference potential A by setting switching element Q6 at OFF. Miller integrating circuit 53 is connected to reference potential A by setting switching element Q7 at ON (not shown).

(Period T1)

In period T1, switching element QHx connected to scan electrode SCx is set at ON, and switching element QLx is set at OFF. Thus, voltage Vc derived by adding voltage Vsc to reference potential A (voltage 0 (V) at this time) is applied to scan electrode SCx to which a forced initializing waveform is applied. In other words, voltage Vc is equal to voltage Vsc.

While, switching element QHy connected to scan electrode SCy is kept in the OFF state, and switching element QLy is kept in the ON state. Thus, reference potential A, namely voltage 0 (V), is applied to scan electrode SCy to which a selective initializing waveform is applied.

(Period T2)

In period T2, switching element QH1 through switching element QHn and switching element QL1 through switching element QLn are kept in the same state as that in period T1. In other words, switching element QHx connected to scan electrode SCx is kept in the ON state, switching element QLx is kept in the OFF state, switching element QHy connected to scan electrode SCy is kept in the OFF state, and switching element QLy is kept in the ON state.

Next, input terminal IN1 of Miller integrating circuit 53 for generating up-ramp voltage L1′ is set at “Hi”. Specifically, a predetermined constant current is input to input terminal IN1. Thus, a certain current flows to capacitor C1, the source voltage of switching element Q1 increases in a ramp shape, and reference potential A starts to increase from voltage 0 (V) in a ramp shape. This voltage increase continues in a period in which input terminal IN1 is kept at “Hi” or until reference potential A arrives at voltage Vr.

At this time, the constant current to be input to input terminal IN1 is generated so that the gradient of the ramp voltage is a desired value (e.g. 1.3 V/μsec). Thus, up-ramp voltage L1′ that increases from voltage 0 (V) to voltage Vi2′ (equal to voltage Vr in the present embodiment) is generated.

Since switching element QHy is kept in the OFF state and switching element QLy is kept in the ON state, up-ramp voltage L1′ is applied to scan electrode SCy.

Since switching element QHx is kept in the ON state and switching element QLx is kept in the OFF state, the voltage derived by adding voltage Vsc to up-ramp voltage L1′ is applied to scan electrode SCx. In other words, up-ramp voltage L1 that increases from voltage Vi1 (equal to voltage Vsc in the present embodiment) to voltage Vi2 (equal to voltage Vsc+voltage Vr in the present embodiment) is applied to scan electrode SCx.

(Period T3)

In period T3, input terminal IN1 is set at “Lo”. Specifically, the input of the constant current to input terminal IN1 is stopped. The operation of Miller integrating circuit 53 is stopped. Reference potential A is applied to scan electrode SC1 through scan electrode SCn by setting switching element QH1 through switching element QHn at OFF and setting switching element QL1 through switching element QLn at ON. Reference potential A is connected to voltage Vs by setting switching element Q13 in clamping circuit 57 of sustain pulse generation circuit 50 at ON and switching element Q14 at OFF. Thus, the voltage of scan electrode SC1 through scan electrode SCn decreases to voltage Vi3 (equal to voltage Vs in the present embodiment).

(Period T4)

In period T4, switching element QH1 through switching element QHn and switching element QL1 through switching element QLn are kept in the same state as that in period T3. Miller integrating circuit 53 and sustain pulse generation circuit 50 are electrically separated from reference potential A by setting switching element Q7 at OFF (not shown).

Next, input terminal IN2 of Miller integrating circuit 54 for generating down-ramp voltage L2 is set at “Hi”. Specifically, a predetermined constant current is input to input terminal IN2. Thus, a certain current flows to capacitor C2, drain voltage of switching element Q2 starts to decrease in a ramp shape, and the output voltage of scan electrode driver circuit 43 also starts to decrease to negative-polarity voltage Vi4 in a ramp shape. This voltage decrease continues in a period in which input terminal IN2 is kept at “Hi” or until reference potential A arrives at voltage Va.

At this time, the constant current to be input to input terminal IN2 is generated so that the gradient of the ramp voltage is a desired value (e.g. −1.0 V/μsec).

When the output voltage of scan electrode driver circuit 43 arrives at negative-polarity voltage Vi4 (equal to voltage Va in the present embodiment), input terminal IN2 is set at “Lo”. Specifically, the input of the constant current to input terminal IN2 is stopped. The operation of Miller integrating circuit 54 is stopped.

Thus, down-ramp voltage L2 that decreases from voltage Vi3 (equal to voltage Vs in the present embodiment) to negative-polarity voltage Vi4 is generated, and applied to scan electrode SC1 through scan electrode SCn.

After input terminal IN2 is set at “Lo” to stop the operation of Miller integrating circuit 54, switching element Q5 is set at ON and reference potential A is set at voltage Va. Switching element QH1 through switching element QHn are set at ON, and switching element QL1 through switching element QLn are set at OFF. Thus, voltage Vc derived by adding voltage Vsc to reference potential A, namely voltage Vcc (equal to voltage Va+voltage Vsc in the present embodiment), is applied to scan electrode SC1 through scan electrode SCn in preparation for the subsequent address period.

In the present exemplary embodiment, thus, a forced initializing waveform and selective initializing waveform are generated in the initializing period of the specific-cell initializing subfield. Then, by controlling switching element QHx, switching element QHy, switching element QLx, and switching element QLy, the forced initializing waveform is applied to scan electrode SCx and the selective initializing waveform is applied to scan electrode SCy.

Down-ramp voltage L2 and down-ramp voltage L4 may decrease to voltage Va as shown in FIG. 7. This decrease may be also stopped when the decreasing voltage arrives at the voltage that is derived by adding voltage Vset2 to voltage Va, for example. Down-ramp voltage L2 and down-ramp voltage L4 may increase immediately after they arrive at a preset voltage. However, after the decreasing voltage arrives at the preset voltage, the voltage may be kept for a certain period, for example.

Next, the operation of generating erasing ramp voltage L3 is described.

(Period T11)

In period T11, reference potential A is connected to scan electrode SC1 through scan electrode SCn by setting switching element QH1 through switching element QHn at OFF, and setting switching element QL1 through switching element QLn at ON. Miller integrating circuit 55 for generating erasing ramp voltage L3 is connected to reference potential A by setting switching element Q6 at ON.

Next, input terminal IN3 of Miller integrating circuit 55 is set at “Hi”. Specifically, a predetermined constant current is input to input terminal IN3. Thus, a certain current flows to capacitor C3, source voltage of switching element Q3 increases in a ramp shape, and reference potential A starts to increase from voltage 0 (V) in a ramp shape. This voltage increase continues in a period in which input terminal IN3 is kept at “Hi” or until reference potential A arrives at voltage Vers.

At this time, the constant current to be input to input terminal IN3 is generated so that the gradient of the ramp voltage is a desired value (e.g. 10 V/μsec). Thus, erasing ramp voltage L3 increasing from voltage 0 (V) to voltage Vers is generated, and applied to scan electrode SC1 through scan electrode SCn. Voltage Vers may be voltage Vs or higher, or may be voltage Vs or lower.

Next, the operation of scan electrode driver circuit 43 in the pre-reset period is described.

(Period T12)

After erasing ramp voltage L3 arrives at voltage Vers, input terminal IN3 is set at “Lo”. Specifically, the input of the constant current to input terminal IN3 is stopped. The operation of Miller integrating circuit 55 is stopped. Miller integrating circuit 55 is electrically separated from reference potential A by setting switching element Q6 at OFF. Switching element QH1 through switching element QHn and switching element QL1 through switching element QLn are kept in the same state as that in period T11. Reference potential A is connected to voltage 0 (V) by setting switching element Q13 in clamping circuit 57 of sustain pulse generation circuit 50 at OFF and setting switching element Q14 at ON (not shown). Thus, the voltage of scan electrode SC1 through scan electrode SCn decreases to voltage 0 (V) as base potential.

(Period T13)

In period T13, switching element QH1 through switching element QHn and switching element QL1 through switching element QLn are kept in the same state as that in period T12. Miller integrating circuit 53 and sustain pulse generation circuit 50 are electrically separated from reference potential A by setting switching element Q7 at OFF (not shown).

Next, input terminal IN2 of Miller integrating circuit 54 for generating down-ramp voltage L5 is set at “Hi”. Specifically, a predetermined constant current is input to input terminal IN2. Thus, a certain current flows to capacitor C2, drain voltage of switching element Q2 starts to decrease in a ramp shape, and the output voltage of scan electrode driver circuit 43 also starts to decrease to negative-polarity voltage Vi4 in a ramp shape. This voltage decrease continues in a period in which input terminal IN2 is kept at “Hi” or until reference potential A arrives at voltage Va.

At this time, the constant current to be input to input terminal IN2 is generated so that the gradient of the ramp voltage is a desired value (e.g. −1.0 V/μsec). Thus, down-ramp voltage L5 that decreases from voltage 0 (V) as base potential to negative-polarity voltage Vi4 is generated and applied to scan electrode SC1 through scan electrode SCn.

(Period T14)

After down-ramp voltage L5 arrives at negative-polarity voltage Vi4 (equal to voltage Va in the present embodiment), input terminal IN2 is set at “Lo”. Specifically, the input of the constant current to input terminal IN2 is stopped. The operation of Miller integrating circuit 54 is stopped. Reference potential A is connected to voltage 0 (V) by setting switching element Q7 at ON, switching element Q13 in clamping circuit 57 of sustain pulse generation circuit 50 at OFF, and switching element Q14 at ON (not shown). Thus, the voltage of scan electrode SC1 through scan electrode SCn increases to voltage 0 (V) as base potential. Switching element QH1 through switching element QHn and switching element QL1 through switching element QLn are kept in the same state as that in period T13.

Then, at time t1 before start of period T15, switching element QHy connected to scan electrode SCy is set at ON, and switching element QLy is set at OFF. Thus, voltage Vc derived by adding voltage Vsc to reference potential A (at this time, voltage 0 (V)) (voltage Vc=voltage Vsc) is applied to scan electrode SCy to which down-ramp voltage L6′ is applied.

(Period T15)

In period T15, switching element QHx connected to scan electrode SCx is kept in the OFF state, switching element QLx is kept in the ON state, switching element QHy connected to scan electrode SCy is kept in the ON state, and switching element QLy is kept in the OFF state.

Next, input terminal IN2 of Miller integrating circuit 54 for generating down-ramp voltage L6 is set at “Hi”. Specifically, a predetermined constant current is input to input terminal IN2. Thus, a certain current flows to capacitor C2, drain voltage of switching element Q2 starts to decrease in a ramp shape, and reference potential A starts to decrease from voltage 0 (V) to negative-polarity voltage Vi4 in a ramp shape. This voltage decrease continues in a period in which input terminal IN2 is kept at “Hi” or until reference potential A arrives at voltage Va.

At this time, the constant current to be input to input terminal IN2 is generated so that the gradient of the ramp voltage is a desired value (e.g. −1.0 V/μsec). Thus, down-ramp voltage L6 that decreases from voltage 0 (V) as base potential to negative-polarity voltage Vi4 is generated.

Since switching element QHx is kept in the OFF state and switching element QLx is kept in the ON state, down-ramp voltage L6 is applied to scan electrode SCx.

Since switching element QHy is kept in the ON state and switching element QLy is kept in the OFF state, the voltage derived by adding voltage Vsc to down-ramp voltage L6 is applied to scan electrode SCy. In other words, down-ramp voltage L6′ that decreases from voltage Vi1 (equal to voltage Vsc in the present embodiment) to voltage Vi5 (equal to voltage Vsc−voltage Va in the present embodiment) is applied to scan electrode SCy.

(Period T16)

After down-ramp voltage L6 arrives at negative-polarity voltage Vi4 (equal to voltage Va in the present embodiment), input terminal IN2 is set at “Lo”. Specifically, the input of the constant current to input terminal IN2 is stopped. The operation of Miller integrating circuit 54 is stopped. Switching element QH1 through switching element QHn are set at OFF, and switching element QL1 through switching element QLn are set at ON. Reference potential A is connected to voltage 0 (V) by setting switching element Q7 at ON, switching element Q13 in clamping circuit 57 of sustain pulse generation circuit 50 at OFF, and switching element Q14 at ON (not shown). Thus, the voltage of scan electrode SC1 through scan electrode SCn increases to voltage 0 (V) as base potential.

In the present exemplary embodiment, thus, down-ramp voltage L6 that decreases from voltage 0 (V) to negative-polarity voltage Vi4 is generated and applied to scan electrode SCx. Down-ramp voltage L6′ that decreases from voltage Vsc to voltage Vi5 is generated and applied to scan electrode SCy.

Down-ramp voltage L5 and down-ramp voltage L6 may decrease to voltage Va as shown in FIG. 7. This decrease may be also stopped when the decreasing voltage arrives at the voltage that is derived by adding voltage Vset2 to voltage Va, for example. Down-ramp voltage L5, down-ramp voltage L6, and down-ramp voltage L6′ may increase immediately after they arrive at a preset voltage. However, after the decreasing voltage arrives at the preset voltage, the voltage may be kept for a certain period, for example.

As discussed above, in the present exemplary embodiment, the following subfields are generated:
a specific-cell initializing subfield having a specific-cell initializing period in which a forced initializing waveform is applied to predetermined scan electrode 22 and a selective initializing waveform is applied to other scan electrodes 22; and
a selective initializing subfield having a selective initializing period in which a selective initializing waveform is applied to all scan electrodes 22.
   In the specific-cell initializing period, the following two fields are alternately generated:
a first field where a forced initializing waveform is applied to the discharge cell formed on odd-numbered scan electrode SC(1+2×N) in view of the layout; and
a second field where a forced initializing waveform is applied to the discharge cell formed on even-numbered scan electrode SC(2+2×N) in view of the layout in the specific-cell initializing period.

Thus, the frequency of performing the forced initializing operation in each discharge cell can be set at once every two fields. In this case, the luminance of black level (e.g. gradation value is “0”) can be therefore made smaller than that of the configuration where the forced initializing operation is performed once per field in each discharge cell, and the contrast ratio of a display image can be improved.

In the final subfield of one field, a pre-reset period is disposed after the sustain period. In the pre-reset period, down-ramp voltage L5 is applied to scan electrode 22. And then, down-ramp voltage L6 is applied to scan electrode 22 to which a forced initializing waveform is applied in the initializing period of the subsequent subfield SF1. Or down-ramp voltage L6′ is applied to scan electrode 22 to which a selective initializing waveform is applied in the initializing period of the subsequent subfield SF1.

Thus, the initializing operation is stabilized in subfield SF1 of the subsequent field, and the later address operation can be performed stably. Therefore, in the present exemplary embodiment, the luminance of black level of an image displayed on panel 10 can be reduced to improve the contrast ratio, the address operation can be stabilized, and the image display quality in a plasma display apparatus can be improved.

In the description of the present exemplary embodiment, a forced initializing waveform is applied to odd-numbered scan electrode SC(1+2×N) in view of the layout in the specific-cell initializing period of the first field, and a forced initializing waveform is applied to even-numbered scan electrode SC(2+2×N) in view of the layout in the specific-cell initializing period of the second field. However, the following configuration may be employed: a forced initializing waveform is applied to even-numbered scan electrode SC(2+2×N) in view of the layout in the specific-cell initializing period of the first field, and a forced initializing waveform is applied to odd-numbered scan electrode SC(1+2×N) in view of the layout in the specific-cell initializing period of the second field.

The forced initializing waveform of the present invention is not limited to the waveform shown in the exemplary embodiment. The forced initializing waveform may be any waveform as long as the initializing discharge is caused in the discharge cell regardless of the operation of the immediately preceding subfield.

In the description of the present exemplary embodiment, all of the selective initializing waveform (down-ramp voltage L4) generated in the selective initializing period and down-ramp voltage L5 generated in the pre-reset period have the same gradient. In the present invention, however, down-ramp voltage L4 and down-ramp voltage L5 are not limited to these waveform shapes. Down-ramp voltage L4 and down-ramp voltage L5 may be any waveform shape as long as the initializing discharge is caused only in the discharge cell having undergone sustain discharge in the immediately preceding sustain period. For example, each of down-ramp voltage L4 and down-ramp voltage L5 may be divided into a plurality of periods, and each of down-ramp voltage L4 and down-ramp voltage L5 may have different gradients between the periods.

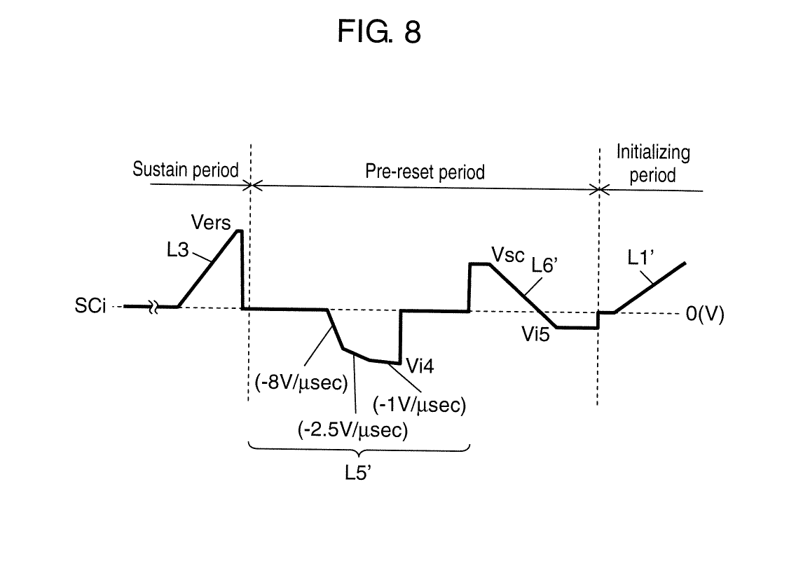

FIG. 8 is a diagram showing one example of another waveform of down-ramp voltage L5 in accordance with the exemplary embodiment of the present invention. For example, in FIG. 8, down-ramp voltage L5′ may be generated in the following processes:
until discharge occurs (for example, from voltage 0 (V) to −100 (V)), the applied voltage to scan electrode 22 is decreased at a gradient (e.g. −8 V/μsec) steeper than that of down-ramp voltage L5;
after that (for example, from −100 (V) to −135 (V)), the voltage is decreased slightly gently (for example, at a gradient of −2.5 V/μsec); and
finally (for example, from −135 (V) to −160 (V)), the voltage is decreased at the same gradient (e.g. −1.0 V/μsec) as that of down-ramp voltage L5.
   Such configuration can produce an effect similar to the above-mentioned one. In this configuration, the period required for generating down-ramp voltage L5′ (and selective initializing waveform) can be made shorter than that when down-ramp voltage L5 is generated. Down-ramp voltage L4′ may be generated in the selective initializing period in a procedure similar to that when down-ramp voltage L5′ is generated.

The selective initializing waveform generated in the specific-cell initializing period is not limited to the shape shown in the exemplary embodiment. The selective initializing waveform generated in the specific-cell initializing period of the present exemplary embodiment is one example of the waveform where no initializing discharge is caused in the discharge cell where a selective initializing operation is performed in the first half of the specific-cell initializing period. For example, the waveform in which voltage 0 (V) is kept in the first half of the initializing period may be employed.

In the present exemplary embodiment, the configuration where down-ramp voltage L6 has the same shape as that of down-ramp voltage L5 has been described. However, the present invention is not limited to this configuration. Down-ramp voltage L6 may be generated at a gradient different from that of down-ramp voltage L5 or a minimum voltage different from that thereof.

In the present exemplary embodiment, the following configuration has been described: the forced initializing operation is performed at a frequency of once every two fields in each discharge cell by repeatedly, alternately generating the first field and second field. However, the present invention is not limited to this configuration.

For example, the forced initializing operation may be performed at a frequency of once every three fields in each discharge cell by sequentially generating the following three fields:
a field having a specific-cell initializing period for applying a forced initializing waveform to scan electrode SC(1+3×N);
a field having a specific-cell initializing period for applying a forced initializing waveform to scan electrode SC(2+3×N); and
a field having a specific-cell initializing period for applying a forced initializing waveform to scan electrode SC(3+3×N).
   Alternatively, the forced initializing operation may be performed at this frequency or lower in each discharge cell. In such a configuration, the luminance of black level of the display image can be further reduced.

A new field may be added to the above-mentioned two fields (first field and second field). For example, a third field where all subfields are selective initializing subfields may be disposed between the first field and second field. Also in this configuration, the luminance of black level of the display image can be further reduced.

Alternatively, a fourth field where an all-cell initializing subfield in which a forced initializing operation is performed in all discharge cells is set as subfield SF1 may be disposed between the first field and second field. In this configuration, the initializing discharge can be caused more stably.

In all of these configurations, in the present invention, down-ramp voltage L6 is applied to the discharge cell where a forced initializing operation is performed in the initializing period of subfield SF1 in the pre-reset period immediately before it, thereby causing second auxiliary discharge. Then, down-ramp voltage L6′ for causing no second auxiliary discharge is applied to the discharge cell where a selective initializing operation is performed in the initializing period of subfield SF1 in the pre-reset period immediately before it.

In the description of the present exemplary embodiment, voltage 0 (V) is applied to sustain electrodes 23 while down-ramp voltage L5 is applied to scan electrodes 22 in the pre-reset period. However, the present invention is not limited to this configuration. In the pre-reset period, the first auxiliary discharge caused by down-ramp voltage L5 is substantially equal to the discharge caused by a selective initializing operation. The voltage applied to sustain electrodes 23 while down-ramp voltage L5 is applied to scan electrodes 22 may be any voltage as long as discharge occurs only in the discharge cell having undergone sustain discharge in the sustain period of the final subfield. For example, the voltage may be in the range from voltage 0 (V) to voltage Ve.

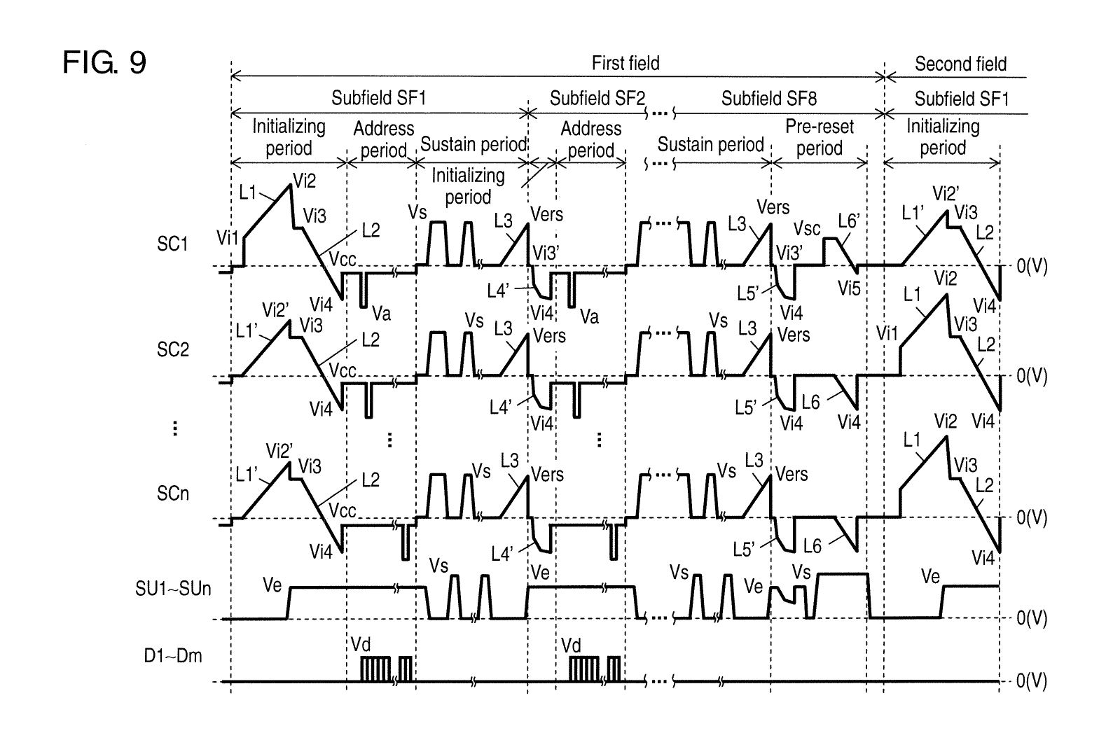

FIG. 9 is a waveform diagram showing another example of the driving voltage waveform to be applied to each electrode of panel 10 in accordance with the exemplary embodiment of the present invention. The driving voltage waveform of FIG. 9 differs from the driving voltage waveform of FIG. 4 in that down-ramp voltage L4′ instead of down-ramp voltage L4 is applied to scan electrodes 22, and down-ramp voltage L5′ instead of down-ramp voltage L5 is applied to scan electrodes 22. However, this different point does not cause difference in operation of panel 10 between the driving voltage waveform of FIG. 9 and that of FIG. 4, so that the description of the different point is omitted.

In the driving voltage waveform of FIG. 9, voltage Ve is applied to sustain electrodes 23 immediately before down-ramp voltage L5′ is applied to scan electrodes 22, and sustain electrodes 23 are kept in a high impedance state (floating state) while down-ramp voltage L5′ is applied to scan electrodes 22. In this configuration, in the discharge cell where sustain discharge is caused in the sustain period of the final subfield, counter discharge is caused between scan electrodes 22 and data electrodes 32 and plane discharge is also caused between scan electrodes 22 and sustain electrodes 23. Therefore, in this case, no initializing discharge occurs in the discharge cell where a selective initializing operation is performed in the initializing period of subfield SF1. Therefore, the discharge by down-ramp voltage L5′ becomes substantially equal to the discharge by a selective initializing operation, so that this configuration becomes substantially equal to the configuration where a selective initializing operation is performed immediately after an erasing operation. Similarly to the above-mentioned configuration, the subsequent address operation can be stabilized. In the present exemplary embodiment, when a selective initializing waveform is applied to a discharge cell regardless of occurrence or no occurrence of discharge in the discharge cell, it is considered that a selective initializing operation has been performed in the discharge cell.

In the present exemplary embodiment, the following configuration has been described: the first subfield (subfield SF1) of one field is set as a specific-cell initializing subfield and a pre-reset period is disposed in the final subfield (e.g. subfield SF8) of one field. However, the present invention is not limited to this configuration. The specific-cell initializing subfield may be subfield SF2 or later. Here, the subfield having a pre-reset period is certainly set as the subfield immediately before the specific-cell initializing subfield. For example, when subfield SF2 is set as a specific-cell initializing subfield, the pre-reset period is disposed after the sustain period of subfield SF1.

Timing charts shown in FIG. 4, FIG. 7, and FIG. 9 are one example in the exemplary embodiment of the present invention, and the present invention is not limited to these timing charts.

In the present exemplary embodiment, an example where one field is constituted by eight subfields has been described. In the present invention, however, the number of subfields constituting one field is not limited to the above-mentioned value. For example, by setting the number of subfields to be larger than eight, the number of gradations displaceable on panel 10 can be further increased.

In the present exemplary embodiment, the example has been described where the luminance weights of the subfields are set at powers of “2”, and the luminance weights of subfield SF1 through subfield SF8 are set at (1, 2, 4, 8, 16, 32, 64, 128). However, the luminance weights set for the subfields are not limited to these numerical values. When the combination of the subfields for determining the gradation is made flexible, for example, the luminance weights are set at (1, 2, 3, 7, 12, 31, 50, 98) or the like, the coding where occurrence of a moving image false contour is suppressed is allowed. The number of subfields constituting one field and the luminance weights of the subfields are set appropriately in response to the characteristics of panel 10 and the specification of plasma display apparatus 1.

Each circuit block shown in the exemplary embodiment of the present invention may be configured as an electric circuit for performing each operation shown in the exemplary embodiment, or may be configured using a microcomputer or the like programmed so as to perform a similar operation.

In the present exemplary embodiment, an example where one pixel is formed of discharge cells of three colors R, G, and B has been described. However, also in a panel where one pixel is formed of discharge cells of four or more colors, the configuration shown in the present embodiment can be applied and a similar effect can be produced.

The above-mentioned driver circuits are one example, and the configurations of them are not limited to the above-mentioned configurations.

The exemplary embodiment of the present invention can be applied to a driving method of the panel by the so-called two-phase driving. In this driving method, scan electrode SC1 through scan electrode SCn are classified into a first scan electrode group and second scan electrode group, and the address period is constituted by a first address period in which a scan pulse is applied to each of the scan electrodes belonging to the first scan electrode group and a second address period in which a scan pulse is applied to each of the scan electrodes belonging to the second scan electrode group.

The exemplary embodiment of the present invention is useful for a panel having an electrode structure where a scan electrode is adjacent to another scan electrode and a sustain electrode is adjacent to another sustain electrode, namely an electrode structure where the electrode array disposed on the front substrate is “ . . . , scan electrode, scan electrode, sustain electrode, sustain electrode, scan electrode, scan electrode, . . . ”.

Each specific numerical value shown in the present exemplary embodiment is set based on the characteristics of panel 10 having a screen size of 50 inches and having 1024 display electrode pairs 24, and is simply one example in the embodiment. The specific numerical values are, for example, up-ramp voltage L1, down-ramp voltage L2, erasing ramp voltage L3, down-ramp voltage L4, down-ramp voltage L4′, down-ramp voltage L5, down-ramp voltage L5′, down-ramp voltage L6, and down-ramp voltage L6′. The present invention is not limited to these numerical values. Numerical values are preferably set optimally in response to the characteristics of the panel or the specification of the plasma display apparatus. These numerical values can vary in a range allowing the above-mentioned effect. The number of subfields and the luminance weight of each subfield are not limited to the values shown in the exemplary embodiment of the present invention, but the subfield structure may be changed based on an image signal or the like.

### INDUSTRIAL APPLICABILITY

In the present invention, the luminance of black level of a display image can be reduced to improve the contrast, the address discharge can be stably caused, and the image display quality can be improved. Therefore, the present invention is useful as a driving method of a panel and a plasma display apparatus

### REFERENCE MARKS IN THE DRAWINGS

1 plasma display apparatus
10 panel
21 front substrate
22 scan electrode
23 sustain electrode
24 display electrode pair
25, 33 dielectric layer
26 protective layer
31 rear substrate
32 data electrode
34 barrier rib
35 phosphor layer
41 image signal processing circuit
42 data electrode driver circuit
43 scan electrode driver circuit
44 sustain electrode driver circuit
45 timing generation circuit
50 sustain pulse generation circuit
51 initializing waveform generation circuit
52 scan pulse generation circuit
53, 54, 55 Miller integrating circuit
56 power recovery circuit
57 clamping circuit
Q1, Q2, Q3, Q5, Q6, Q7, Q11, Q12, Q13, Q14, QH1 through QHn, QL1 through
QLn switching element
C1, C2, C3, C11, C31 capacitor
Di1, Di2, Di31 diode
R1, R2, R3 resistor
L11 inductor
L1, L1′ up-ramp voltage
L2, L4, L4′, L5, L5′, L6, L6′ down-ramp voltage
L3 erasing ramp voltage

1. A driving method of a plasma display panel for performing gradation display while one field includes a plurality of subfields each of which has an initializing period, an address period, and a sustain period, the plasma display panel having a plurality of discharge cells each of which has a display electrode pair formed of a scan electrode and a sustain electrode, the driving method comprising:
disposing a specific-cell initializing subfield having an initializing period in which a forced initializing operation is performed in a specific discharge cell;
disposing a pre-reset period after the sustain period in the subfield immediately before the specific-cell initializing subfield; and
causing, in the pre-reset period, first auxiliary discharge in a discharge cell that has undergone sustain discharge in the sustain period immediately before the pre-reset period, and then causing second auxiliary discharge in a discharge cell where the forced initializing operation is performed in the initializing period of the specific-cell initializing subfield immediately after the pre-reset period.

2. The driving method of the plasma display panel of claim 1, wherein
a voltage that is applied to the discharge cells in order to cause the first auxiliary discharge is a first ramp voltage that decreases from voltage 0 (V) to negative-polarity voltage, and
a voltage that is applied to the discharge cells in order to cause the second auxiliary discharge is a second ramp voltage that decreases from voltage 0 (V) to negative-polarity voltage.

3. The driving method of the plasma display panel of claim 2, wherein
the second ramp voltage is applied to the scan electrodes, and a positive-polarity voltage is applied to the sustain electrodes while the second ramp voltage is applied to the scan electrodes.

4. The driving method of the plasma display panel of claim 2, wherein
a third ramp voltage is applied to a discharge cell where the second auxiliary discharge is not caused while the second ramp voltage is applied to a discharge cell where the second auxiliary discharge is caused, the third ramp voltage decreasing from a predetermined positive-polarity voltage to a voltage higher than a minimum voltage of the second ramp voltage.

5. The driving method of the plasma display panel of claim 1, wherein
the specific-cell initializing subfield is set as a first subfield of one field, and a subfield having the pre-reset period is set as a final subfield of the one field.

6. A plasma display apparatus comprising:
a plasma display panel that has a plurality of discharge cells each of which includes a display electrode pair formed of a scan electrode and a sustain electrode, has a plurality of subfields having an initializing period, an address period, and a sustain period in one field, has a subfield having a specific-cell initializing period, and performs gradation display;
a sustain electrode driver circuit for driving the sustain electrodes; and
a scan electrode driver circuit that generates one of a forced initializing waveform and a selective initializing waveform and applies the one to the scan electrodes in the initializing period, and applies the forced initializing waveform to a specific scan electrode in the specific-cell initializing period, the forced initializing waveform causing initializing discharge in the discharge cells, the selective initializing waveform causing initializing discharge in a discharge cell that has undergone sustain discharge in the sustain period of an immediately preceding subfield,
wherein a pre-reset period is disposed after the sustain period in a subfield immediately before a subfield having the specific-cell initializing period,
wherein the scan electrode driver circuit applies a first ramp voltage to the scan electrodes in the pre-reset period, and then applies a second ramp voltage to a scan electrode to which the forced initializing waveform is applied in the specific-cell initializing period immediately after the pre-reset period, the first ramp voltage causing first auxiliary discharge in a discharge cell that has undergone sustain discharge in the sustain period immediately before the pre-reset period, and
wherein the sustain electrode driver circuit applies a positive-polarity voltage to the sustain electrodes while the scan electrode driver circuit applies the second ramp voltage to the scan electrodes.

7. The plasma display apparatus of claim 6, wherein
the scan electrode driver circuit generates the first ramp voltage and the second ramp voltage as ramp voltages decreasing from voltage 0 (V) to a negative-polarity voltage.

8. The plasma display apparatus of claim 7, wherein
while the second ramp voltage is applied to the scan electrodes, the scan electrode driver circuit applies a third ramp voltage to a scan electrode to which the selective initializing waveform is applied in the specific-cell initializing period immediately after the pre-reset period, the third ramp voltage decreasing from a predetermined positive-polarity voltage to a voltage higher than a minimum voltage of the second ramp voltage.
